(19) United States
(12) Patent Application Publication
(10) Pub. No.: US 2004/0012648 A1
(43) Pub. Date: Jan. 22, 2004

(54) Ink-jet printing apparatus and recovery treatment method thereof

(75) Inventors: Yoshito Mizoguchi, Kanagawa (JP); Isao Ebisawa, Tokyo (JP); Shinichi Sato, Kanagawa (JP); Yoshihide Aikawa, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/619,212

(22) Filed: Jul. 15, 2003

(30) Foreign Application Priority Data
Jul. 16, 2002 (JP) 2002-207552
Dec. 2, 2002 (JP) 2002-349386
Dec. 2, 2002 (JP) 2002-349384
Jul. 8, 2003 (JP) 2003-272069

(51) Int. Cl. B41J 29/393

(52) U.S. Cl. 347/19

(57) ABSTRACT

An ink-jet printing apparatus according to the present invention has a main tank storing ink, a sub-tank releasably connectable with the main tank through an ink supply passage and a printing head for ejecting ink supplied from the sub-tank, for performing printing by ejecting ink from the printing head to a printing medium. The apparatus includes ink supply controller for supplying ink from the main tank to the sub-tank through the ink supply passage during a period after completion of printing at preceding time and before starting printing at next time, and ink draining controller for performing ink draining at least a part of ink remaining in the sub-tank during the period after completion of printing at preceding time and before starting printing at next time and in advance of ink supply by the ink supply controller.

This application claims priority from Japanese Patent Application Nos. 2002-207552 filed Jul. 16, 2002, 2002-349386 filed Dec. 2, 2002, 2002-349384 filed Dec. 2, 2002 and 2003-272069 filed Jul. 8, 2003, which are incorporated hereinto by reference.

### BACKGROUND OF THE INVENTION

1. Field of the Invention

The present invention relates to an ink-jet printing apparatus and a recovery treatment method in the ink-jet printing apparatus mainly for stabilizing color reproduction ability of an output image.

2. Description of the Related Art

As the conventional ink-jet printing apparatus, there is so-called serial scan type ink-jet printing apparatus exchangeably mounting a printing head as printing means and ink tanks as ink containers on a carriage movable in a primary scanning direction. This printing system sequentially performs printing on printing mediums by repeating primary scan of the carriage mounting the printing head and the ink tank and auxiliary scan (feeding) of the printing mediums.

Considering realizing a micro-printer applicable for PDAs (Personal Digital Assistants) or s cameras, since size of the carriage becomes small, the storage capacity of ink containers to be mounted on the carriage has to be extremely small. If storage capacity of the ink tank on the carriage is extremely small, frequency of exchange of the ink tanks would become high, and exchange of the ink tanks during a single printing operation would become necessary.

In order to solve the problem, Japanese Patent Application Laid-Open No. 2000-334982 discloses an ink-jet printing apparatus employing an ink supply system, in which each time when the carriage is moved to a predetermined stand-by position, an ink is filled from a separately provided ink receptacle member (hereinafter referred to as main tank which is normally much greater than the ink tank on the carriage) to the ink tank on the carriage (hereinafter referred to as sub-tank) at a given appropriate timing (also referred to as pit-in ink supply method).

In this apparatus, at every occasion of printing image on one printing medium for example, the carriage has to be moved to the predetermined stand-by position and the sub-tank and the main tank are connected with each other by a joint member at an appropriate timing for filling the ink from the main tank to the sub-tank. Accordingly, the problem due to quite small ink storage capacity of the sub-tank on the carriage can be solved.

However, in the construction set forth above, the inventors have gotten the following finding as a result of extensive study. When the ink-jet printing apparatus is left in non-use for a relatively long period and thereafter used for printing, color tone of the image could become unnatural. Also, when the same image is printed for a number of times, color tones between images of a plurality of sheets could be different.

Such unnaturality of color tone or inconsistency of color between the printed products of the same image is particularly not favorable as a printer for cameras for printing photographs.

Such a phenomenon is caused due to condensation of the ink in the sub-tank by leaving the printing apparatus under low humidity environment for a long period of time. This problem can be reduced by providing a mechanism closing an opening portion of the sub-tank as required, selecting material of the sub-tank to the one having smaller gas permeability or increasing thickness of the sub-tank.

However, these measures cannot be ultimate solutions unless evaporation becomes zero. Also, such measures could cause an increase of costs and enlargement of sizes of the sub-tanks to hinder down-sizing.

On the other hand, according to further extensive study made by the inventors, it has been found that when the ink-jet printing apparatus is left in non-use for a relatively long period of time, viscosity of the ink in the sub-tank is significant to reach the ink viscosity far beyond the ink viscosity of the ink normally used in the ink-jet printer to make it impossible to recover nozzles of the printing head.

FIGS. 19A to 19D are schematic representations for explaining a relationship between the sub-tank and remaining amount of ink in the sub-tank in time series. At first, FIG. 19A shows a state where ink is filled in the sub-tank in a pit-in ink supply system. When printing is completed, it becomes a state where ink amount used for printing is consumed, as shown in FIG. 19B. It should be noted that, in case of application of the pit-in ink supply system to a compact printer, the sub-tank has quite small capacity. For example, ink storage amount per color is 0.4 ml (=400 μl). In FIG. 19A, 0.4 ml of ink is filled. In FIG. 19B, 0.2 ml, which is half of ink filled in the sub-tank, is consumed and 0.2 ml of ink remains.

As left in the state shown in FIG. 19B, volatile components, such as water, in the ink are evaporated from the sub-tank. While evaporation speed of volatile component is variable depending upon material and thickness of the sub-tank, and material, structure and so on of the cap for preventing ink in the nozzle of the printing head from drying, volatile component is nevertheless evaporated at a certain speed. For example, assuming that evaporation speed in each color of ink is 0.002 ml per day (=2 μl/day), about 100 μl is evaporated in fifty days, and an evaporation rate from the initial weight becomes 50%. By leaving a further longer period, while evaporation speed can be lowered slightly, it finally reaches a state where volatile solvent component in ink is evaporated out (state shown in FIG. 19C). It should be noted that the evaporation speed herein referred to is the evaporation speed under condition where drying is most significant among operation guaranteed environmental conditions.

As ink composition to be used in typical ink-jet printing apparatus, coloring component as non-volatile dye or pigment is less than or equal to about 10%, ratio of solvent having low volatility (e.g. glycerin, ethylene glycols) is about 15% to 40%, and remaining contents are volatile water or alcohols. Strictly, the solvent having low volatility evaporates in a little amount. However, since evaporation amount of such solvent having low volatility is far smaller than that of water or the like, such coloring component and solvent having low volatility is hereinafter referred to as “non-volatile solvent” for the purpose of explanation, and the ratio is assumed to be 25%. Then, in the foregoing example, ink remaining amount 200 μl×volatile component ratio 0.75=150 μl can be evaporated. Assuming that 2 μl is evaporated per day, volatile component such as water can be evaporated out in about seventy-five days. This point will be referred to as evaporation limit (in practice, further evaporation is continued even after the evaporation limit since the solvent having low volatility evaporates a little amount gradually).

While depending upon composition of ink, viscosity of such ink is about 2.0 mPas in non-evaporated state and 10.0 mPas in 50% evaporated state in case of the ink in the sixth embodiment of the present invention which will be discussed later. In contrast to this, viscosity of ink evaporated up to 75% of evaporation limit, reaches greater than or equal to about 400 mPas which is greater than or equal to about two hundreds times of ink viscosity in normal, non-evaporated state.

When such ink of high viscosity is present in the nozzle, ink cannot be sucked by suction recovery method of the conventional ink-jet printing apparatus and whereby ejection failure can be caused in the nozzle. It should be appreciated that such phenomenon is a problem specifically found in the pit-in ink supply system using the sub-tank of small capacity, in which condensation of ink becomes high by leaving with remaining small amount of ink in the sub-tank.

### SUMMARY OF THE INVENTION

The present invention has been worked out to solve the problems set forth above. It is an object of the present invention to reduce a problem of condensation of ink in a sub-tank to be caused in a pit-in ink supply method using the sub-tank of small capacity.

Another object of the present invention is to reduce unnaturalness of color tone of image associated with condensation of ink even when condensation of ink occurred.

A further object of the present invention is to reduce difference of color tone between a plurality of sheet of images associated with condensation of ink even when condensation of ink occurred.

A still further object of the present invention is to permit prevention of ejection failure of nozzle and obtaining of good quality of image even when the sub-tank is left in a non-use state for a long period of time.

A yet further objection of the present invention is to make reproductivity of color high even when condensation of ink is occurred.

In the first aspect of the present invention, there is provided an ink-jet printing apparatus having a main tank storing ink, a sub-tank releasably connectable with the main tank through an ink supply passage and a printing head for ejecting ink supplied from the sub-tank, for performing printing by ejecting ink from the printing head to a printing medium, comprising:

ink supply means for supplying ink from the main tank to the sub-tank through the ink supply passage within a period after completion of printing at preceding time and before starting printing at next time; and

ink draining means for performing ink draining for draining at least a part of ink remaining in the sub-tank within the period after completion of printing at preceding time and before starting printing at next time and in advance of ink supply by the ink supply means.

In the second aspect of the present invention, there is provided an ink-jet printing apparatus having a plurality of main tanks storing inks, and a plurality of sub-tanks connected to a printing head and releasably connectable with the plurality of main tanks through respective ink supply passages, comprising:

calculating means for calculating remaining ink amount in each sub-tank at completion of printing operation; and

first draining control means for controlling draining of ink from each sub-tank on the basis of results of calculation by the calculating means so that remaining ink amounts in the plurality of sub-tanks are substantially equal with each other.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a front elevation view of a camera with a built-in printer, to which the present invention is applicable;

FIG. 2 is a perspective view of a media pack which can be loaded in the camera of FIG. 1;

FIG. 3 is a perspective view showing an arrangement of main components within the printer of FIG. 1;

FIG. 4 is a schematic representation of an ink supply recovery system;

FIGS. 5A to 5G are schematic representations of condensation of ink in a sub-tank;

FIGS. 6A to 6I are schematic representations of fluctuation of condensation ratios of respective colors;

FIG. 7 is a schematic block diagram of electric system of an ink-jet printing apparatus;

FIG. 8 is a flow chart explaining sequence for performing draining process according to the twenty-first embodiment of the present invention;

FIGS. 9A to 9F are schematic representations explaining fluctuation of density ratio in the twenty-first embodiment of the present invention;

FIG. 10 is a flow chart explaining sequence for performing draining process according to the twenty-second embodiment of the present invention;

FIGS. 11A to 11E are schematic representations explaining fluctuation of density ratio in the twenty-second embodiment of the present invention;

FIG. 12 is a flow chart explaining sequence for performing draining process according to the twenty-fourth embodiment of the present invention;

FIG. 13 is a flow chart explaining sequence for performing draining process according to the twenty-fourth embodiment of the present invention;

FIGS. 14A to 14E are schematic representations showing states of ink in the sub-tank for explaining the first embodiment;

FIG. 15 is a flow chart explaining a sequence to perform an ink draining process according to the second embodiment of the present invention;

FIG. 16 is an illustration for explaining a sequence to perform an ink draining process according to the second embodiment of the present invention;

FIG. 17 is a table showing a relationship between a range of a time count value X and an ink drainage amount;

FIG. 18 is a flow chart explaining a sequence for obtaining a dot count value Y;

FIGS. 19A to 19D are schematic representations explaining a relationship between the sub-tank and a remaining ink amount in the sub-tank in time sequence (prior art);

FIGS. 20A to 20C are graphic charts explaining extent of evaporation of remaining ink in the sub-tank and influence thereof as left in the condition where ink (200 μl of ink) in the sub-tank is left;

FIGS. 21A to 21E are schematic representations explaining an effect of the fifth embodiment of the present invention, relative to the prior art shown in FIGS. 19A to 19D;

FIGS. 22A to 22C are graphic charts explaining extent of evaporation of remaining ink in the sub-tank and influence thereof as left in the condition where ink (100 μl of ink) in the sub-tank is left;

FIG. 23 is a flow chart explaining a sequence to perform an ink draining process of the seventh embodiment of the present invention;

FIG. 24 is a graphic chart showing a relationship between an ink evaporation rate and viscosity to be used in the seventh embodiment of the present invention;

FIG. 25 is a flowchart explaining a sequence to perform an ink draining process of the eighth embodiment of the present invention;

FIGS. 26A and 26B are schematic representations explaining a case where ink with increased viscosity remains after ink drainage process;

FIG. 27 is a flow chart explaining a sequence to perform an ink draining process of the ninth embodiment of the present invention;

FIGS. 28A to 28F are schematic representations showing states of remaining ink in the sub-tank for explaining the tenth embodiment of the present invention;

FIG. 29 is a schematic representation showing flow of ink in the case where pit-in ink supply is performed before ink drainage process; and

FIG. 30 is a flow chart explaining a sequence to perform an ink draining process of the tenth embodiment of the present invention.

### DETAILED DESCRIPTION OF PREFERRED EMBODIMENTS

The present invention will be discussed hereinafter in detail with reference to the drawings. In advance of disclosure of the preferred embodiments, a construction of an ink-jet printing apparatus, to which the present invention is applied, will be discussed. While the following discussion will be given in terms of an ink-jet printing apparatus integrated with a camera portion, it is not inherent to provide a camera portion in the ink-jet printing apparatus according to the present invention.

[Basic Structure]

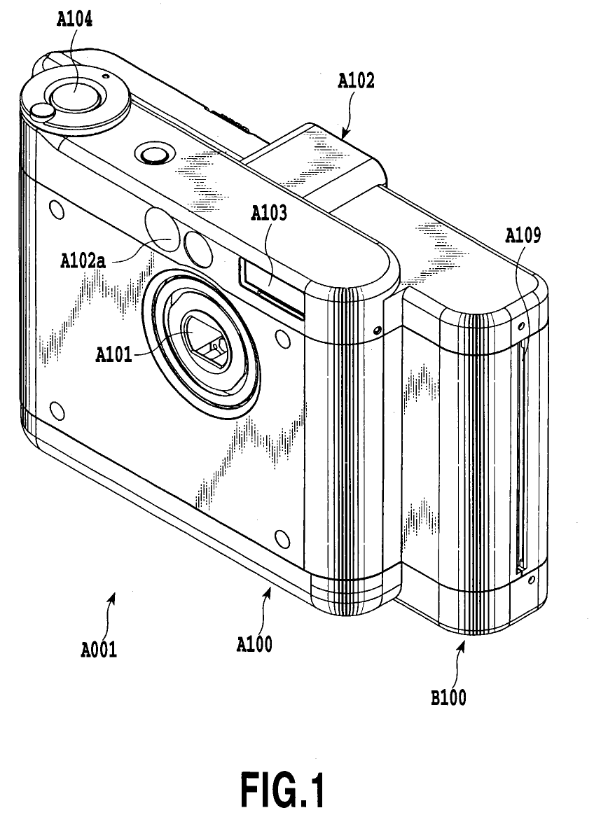

Firstly, a basic structure of a device according to the present invention will be explained in view of FIGS. 1 to 4. The device explained in the present embodiments is constituted as an information processing equipment comprising a photographing section for optically photographing an image and then converting the photographed image into an electric signals (hereinafter, also referred to as “camera section”) and an image recording section for recording image on the basis of thus obtained electric signals (hereinafter, also referred to as “printer section”). Hereinafter, the information processing equipment in the present embodiments is explained in the name of a “printer-built-in camera”.

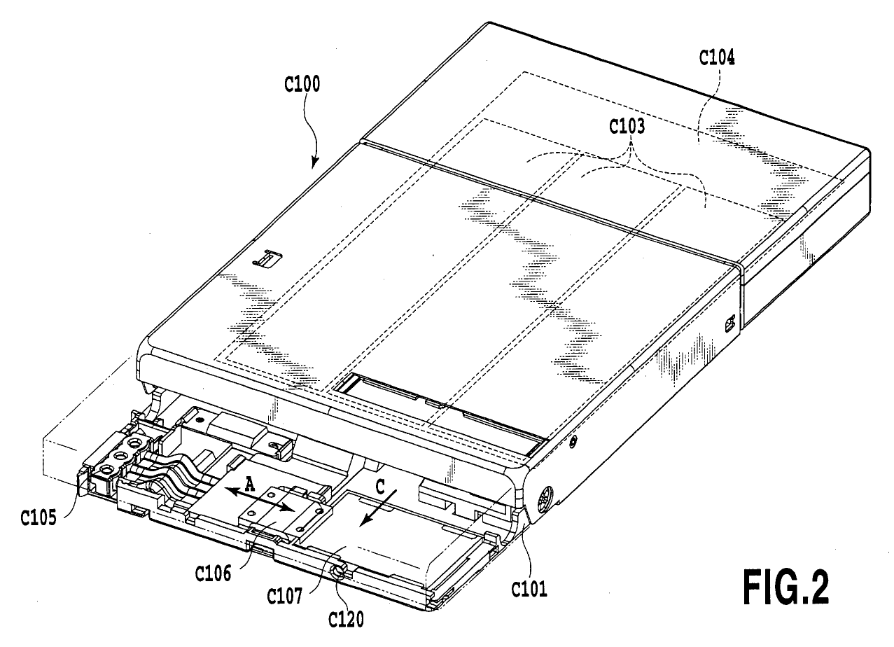

In FIG. 1, in a main body A001 there is incorporated a printer section (recording apparatus section) B100 at the backside of a camera section A100 in an integral manner. The printer section B100 records an image by using inks and printing mediums which are supplied from a medium pack C100 shown in FIG. 2. In the present structure, the medium pack C100 is inserted to the printer section B100 at a slot located at the right hand as shown in FIG. 1, and finished printed matter is output from a printed matter outlet A109.

In the case of performing a recording by the printer section B100, the main body A001 can be placed facing a lens A101 down. In this recording position, a recording head B120 of the printer section B100, which will be described below, is made to be positioned to eject inks in the downward direction. The recording position can be made to be the same position as that of photographing condition by the camera section A100 and thus is not limited to the recording position as mentioned above. However, in view of a stability of a recording operation, the recording position capable of ejecting the inks in the downward direction is preferred.

There follows the explanations of the basic mechanical structure according to the present embodiment under the headings of 1 as “Camera Section”, 2 as “Medium Pack”, 3 as “Printer Section” and 4 as “Electric Control System”.

1: Camera Section

The camera section A100, which basically constitutes a conventional digital camera, constitutes the printer-built-in digital camera having an appearance in FIG. 1 by being integrally incorporated into the main body A001 together with a printer section B100 described below. In FIG. 1, A101 denotes a lens; A102 denotes a viewfinder; A102a denotes a window of the viewfinder; A103 denotes a flush; and A104 denotes a shutter release button. A liquid crystal display section (outer display section) is provided at a side of the body opposite to the lens. The camera section A100 performs processing of data photographed by CCD, recording of images to a solid state memory card (e.g. CF card), display of the images and a transmission of various kinds of data with the printer section B100. A109 denotes a discharge part for discharging a printing medium C104 on which the photographed image is recorded. A not shown battery is used as a power source for the camera section A100 and the printer section B100.

2: Medium Pack

A medium pack C100 is detachable relating to a main body A001 and, in the present apparatus, is inserted through a not shown slot of an inserting section of the main body A001, thereby being placed in the main body A001. The inserting section is closed when the medium pack C100 is not inserted therein, and is opened when the medium pack is inserted therein. FIG. 2 illustrates a status wherein a cover is removed from the main body A001

The pack body C101 contains ink packs C103 corresponding to the said main tank (i.e. ink bags), and printing mediums C104 (i.e. ink jet printing mediums). In FIG. 2, the ink packs C103 are held under the printing mediums C104. In the case of the present embodiment, three ink packs C103 are provided so as to separately hold the inks of Y (yellow), M (magenta) and C (cyan), and about twenty sheets of the printing mediums C104 are stored in pile. A combination of those inks and the printing mediums C104 suitable for recording an image is selected to be stored within the medium pack C100.

Accordingly, the various medium packs C100 each having a different combination of the inks and the printing mediums (for example, medium packs for super high-quality image; for normal image; for stickers; and for partitioned stickers) are prepared and, according to a kind of images to be recorded and purposes of use of the printing medium on which an image is formed, a medium pack C100 is selectively inserted in the main body A001, thereby being able to perform an ensured recording of the images in compliance with the purposes by employing the most suitable combination of the ink and the printing medium. Further, the medium pack C100 is equipped with the below-mentioned EEPROM to which is recorded the identification data such as kinds or remaining amounts of the inks and the printing mediums contained in the medium pack.

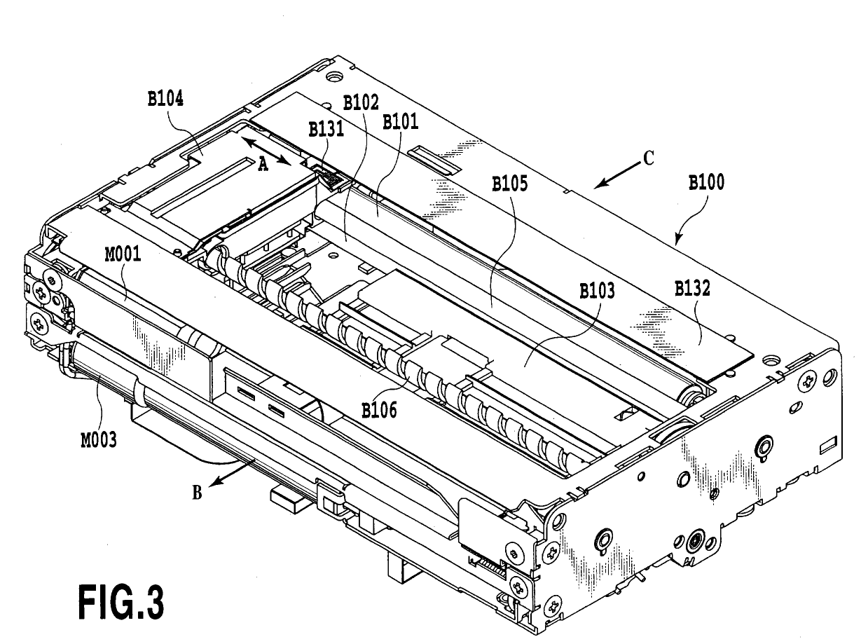

When the medium pack C100 is inserted in the main body A001 (as shown in FIG. 3: inserted to printer section B100 from a direction of an arrow C), the ink pack C103 is connected to an ink supplying system in the main body A001, through three joints C105 each corresponding to ink of Y, M or C. On the other hand, the printing mediums C104 are separated one by one using a separating mechanism which is not shown, and then sent to a direction of an arrow C by a paper feeding roller equipped inside the main body.

Further, the pack body C101 comprises a wiper C106 for wiping a recording head of the after-mentioned printer section, and an ink absorption body C107 for absorbing the spent inks discharged from the printer section.

3: Printer Section

FIG. 3 shows the printer section B100 according to the present embodiment which is a serial type apparatus employing an ink jet recording head. This printer section B100 is explained under the headings of 3-1 “Printing Operating Section”; and 3-2 “Ink Supplying System”, respectively.

3-1: Printing Operating Section

FIG. 3 is a perspective view of the printer section B100 without its outer casing.

To the main body of the printer section B100, the medium pack C100 is inserted from the direction of an arrow C as shown in FIG. 3. The printing medium C104 sent to the direction of an arrow C from the medium pack C100, while being sandwiched between a LF roller B101 and a LF pinch roller B102 of the below-mentioned printing medium carrying system, is carried on a pressure plate B103 to a sub-scanning direction indicated by an arrow B. B104 denotes a carriage which reciprocates toward a main scanning direction indicated by an arrow A along a guiding shaft B105 and a leading screw B106.

Inside a bearing of the carriage B104 for the leading screw B106, a protruding screw pin is fixed with a spring. An engage of a tip of the screw pin B109 with a helical thread formed on the outer circumference of the leading screw B106 converts a rotation of the leading screw B106 to a reciprocating movement of the carriage B104.

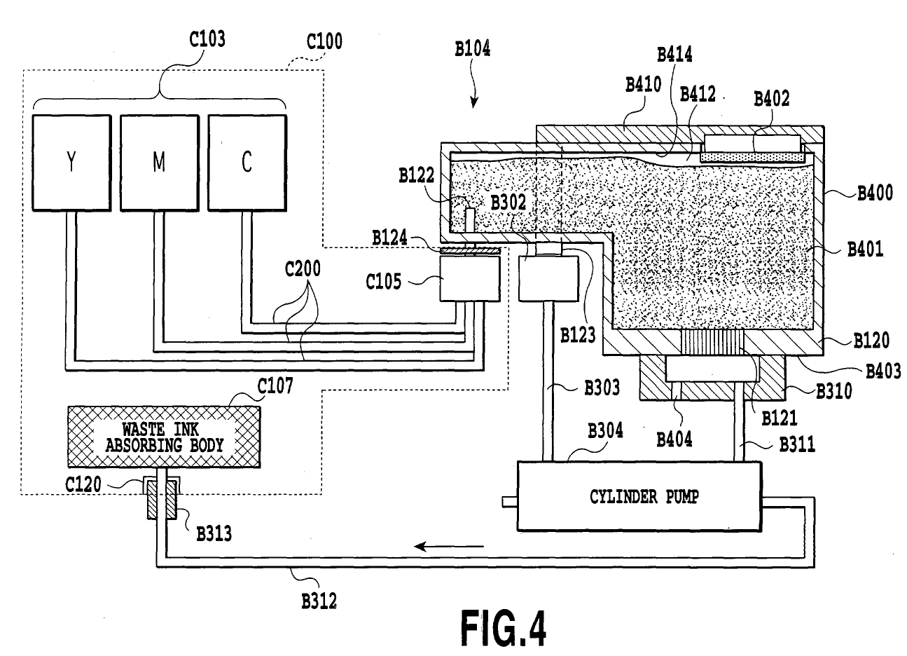

The carriage B104 is equipped with an ink jet recording head B120 (shown in FIG. 4) capable of ejecting the inks of Y, M and C as explained later, and a sub-tank for reserving inks to be supplied to the recording head B120. Formed on the recording head B120 are a plurality of ink ejection openings B121 (see FIG. 4), which are aligned with the direction crossing with the main scanning direction indicated by the arrow A. The ink ejection openings B121 form nozzles capable of ejecting inks supplied from the sub-tank. As a generating means of energy for discharging the inks, an electro-thermal converting element equipped with each of the nozzles may be used. The electro-thermal converting element generates bubble in the inks within the nozzle by a heating and thus generated foaming energy causes an ejection of the ink droplet from the ink ejection opening B121.

The sub-tank has a capacity smaller than the ink packs (main tanks) C103 contained in the media pack C100, and made to be a size sufficient for storing a required amount of ink for recording an image corresponding to at least one sheet of printing medium C104. In the sub-tank, there are ink reserving sections for each of the inks of Y, M and C, on each of which is formed the ink supplying section and the negative pressure introducing sections, wherein those ink supplying sections are individually connected to the corresponding three hollow needles B122 (see FIG. 4) and their negative pressure introducing sections can be connected to a common air suction opening B123 (see FIG. 4). As will be mentioned below, sub-tanks are supplied with inks from the ink packs (main tanks) C103 in the medium pack C100 when the carriage B104 moves to a home position.

A movement position of the carriage B104 is detected by an encoder sensor B131 on the carriage B104 and a linear scale B132 on the main body of the printer section B100. Also, a fact that the carriage B104 moves to the home position is detected by a HP sensor on the main body of the printer section B100.

A not shown controlling mechanism controls a height of the carriage 104, thereby achieving an adjustment of a distance between the recording head B120 and the printing medium C104 on the pressure plate B103. The leading screw B106 is rotatably driven by a carriage motor M001 through a screw gear, an idler gear and a motor gear. A flexible cable electrically connects the recording head B120 to an electrical circuit board in the main body.

The recording head B120 moves together with the carriage B104 in the main scanning direction indicated by the arrow A and concurrently ejects the inks from the ink ejection openings B121 in accordance with the image signals, thereby recording an image corresponding to one band on the printing medium on the pressure plate B103. An alternate repeat of a recording operation of an image corresponding to one band by such recording head B120 and a conveying operation of the predetermined amount of the printing medium toward the sub-scanning direction indicated by the arrow B by means of the below-mentioned printing medium conveying system enables a sequential recording of the images on the printing medium.

3-2: Ink Supplying System

FIG. 4 is a perspective view showing a component part of an ink supplying system of the printer section B100

A joint C105 of the medium pack C100 installed to the printer section B100 is positioned below the needles B122 on the carriage B104 moved to a home position. The main body of the printer section B100 is equipped with a joint fork B301 (not shown) positioned below a joint C105, and an upward movement of the joint C105 caused by the joint fork establishes a connection of the joint C105 to the needles B122. As a result thereof, an ink supplying path is formed between the ink packs C103 in the medium pack C100 and the ink supplying sections on the sub-tank B400 on the carriage B104.

Further, the main body of the printer section B100 is equipped with a suction joint B302 for connecting with an air suction opening B123 of the carriage B104 moved to the home position. This suction joint B302 is connected to a cylinder pump B304 of a pump serving as a negative pressure generating source, through a suction tube B303. The suction joint B302 is connected to the air suction opening B123 on the carriage B104 according to the upward movement caused by a not shown joint lifter. In the light of the foregoing, a negative pressure introducing path, between a negative pressure introducing section of the sub-tank on the carriage B104 and the cylinder pump B304, is formed.

The joint lifter makes the joint fork B301 and the joint C105 move up and down together with the suction joint B302 by a driving force of the joint motor M003. Thus, the formation of ink supply path and the formation of the negative pressure introducing path are accomplished at the same time.

The negative pressure introducing section of the sub-tank is equipped with a gas-liquid partition member B402 which allows a passing through of air but prevents a passing through of the inks. The gas-liquid partition member allows a passing through of the air in the sub-tank to be suctioned through the negative pressure introducing path, thereby forcing an ink to be supplied to the sub-tank from the medium pack C100. Then, when the ink is sufficiently supplied to the extent that the ink in the sub-tank reaches the gas-liquid partitioning member, the gas-liquid partitioning member prevents the passing through of the inks, thereby automatically stopping a supply of the inks. The gas-liquid partitioning member is situated at the ink supplying section in the ink storing sections for the respective inks in the sub-tank, and thus the ink supply is automatically stopped with respect to each ink storing section.

The main body of the printer section B100 is further equipped with a suction cap B310 capable of capping the recording head B120 on the carriage B104 which moved to the home position. The suction cap B310 is introduced the negative pressure thereinto from the cylinder pump B304 through suction tube B311, so that the inks can be suctioned and emitted (suction recovery processing) from the ink ejection openings B121 of the recording head B120. Further, the recording head B120, as required, makes the ink which does not contribute to a recording of an image, ejection into the suction cap B310 (preliminary ejection processing). The ink within the suction cap B310 is discharged into the ink absorption body C107 in the medium pack C110 from the cylinder pump B304 through a waste water liquid tube B312 and a waste liquid joint B313.

The cylinder pump B304 is driven by a pump motor M004. The pump motor M004 also functions as a driving source by which the said joint lifter and the wiper lifter are moved up and down. The wiper lifter makes the wiper C106 of the medium pack C100 placed in the printer section B100 move upwardly, thereby displacing the wiper C106 to a position capable of wiping of the recording head B120.

It should be noted that for tubes such as B303, B311, and B312, not shown valves may be provided as required. Upon each operation of the pump motor M003, those valves are opened and closed so that they selectively perform suction for each individual color of ink or suction for two or more colors of inks in a lump, but does not affect suction or draining operation of other color of ink during operation for lifting up and down.

The cylinder pump B304 is placed in stand-by state on HP side of the pump in a stand-by state of the printer, with a pump HP sensor (not shown) detecting that the operating position of the pump is at its home position.

Here, discussion is given for a camera with a built-in printer, in which a camera portion A100 and a printer portion B100 are integrated together. However, it is also possible in the present invention to construct the camera portion A100 and the printer portion B100 as separate units and to connect these separate units through an interface to achieve the same functions.

(Detailed Description of Ink Supply Recovery System)

The foregoing is a general discussion of the ink supply recovery system employing the typical pit-in supply system. Detail of the ink supply recovery system will be discussed hereinafter. FIG. 4 is a schematic representation of the ink supply recovery system similar to the above. While there are some overlapping explanations, a sequence of operation will be discussed with reference to FIGS. 2 and 4.

In FIG. 2, received in the media pack 100 are three ink packs (main tanks) C103 respectively filled with three colors, i.e. Y (yellow), M (magenta) and C (Cyan), of inks. These three ink packs C103 are connected to three joints (ink joints) via three ink supply passages C200.

In FIG. 4, mounted on the carriage B104 are sub-tanks (also referred to as carriage tanks) B400 respectively storing Y, M and C inks, and a printing head B120 having a plurality of ink ejection openings (nozzles) B121 for ejecting three groups (Y, M, C) of inks supplied from respective carriage tanks B400.

In each of ink receptacle portions (ink supply portions) of the sub-tanks B400, ink absorbing bodies (sponges) B401 formed from a porous body, including foamed body and fibrous body formed from e.g. polypropylene fibers, are disposed in a state substantially filling up the receptacle portions of respective sub-tanks B400. On the other hand, in respective receptacle portions (ink supply portions) for respective inks in the sub-tanks B400, needles (ink introducing portion) B122 having downwardly projecting through holes are provided respectively, as shown in FIG. 4. These three needles B122 respectively become connectable with three rubber joints C105 of the media pack C100. At the tip end portions of the needles B122, a lateral hole is formed for enabling ink supply. Tip ends of the needles are closed with sharply tilted end face.

In upper portions of respective ink supply portions of the sub-tanks B400, vacuum pressure introducing portions B410 are formed. In these vacuum pressure introducing portions B410, porous membranes (ink full valve) B402 provided water repellent and oil repellent treatment for serving as vapor-liquid separating members permeating air and blocking ink, are provided respectively. Since ink is blocked with such porous membranes B402, refilling of ink is automatically stopped when the liquid surface of the ink in the sub-tank B400 reaches the porous membrane B402. If water repellent and oil repellent treatment is not provided, the porous membrane is easily wetted by ink. Particularly, after duration, ink may penetrate into pores of vapor-liquid separation membrane in easily wetted portion for substantially not achieving vapor-liquid separation effect to lower air introduction efficiency and whereby to lower ink supply performance.

Each vacuum pressure introducing portion B410 of the sub-tank B400 is communicated with an air suction opening B123 common for three colors and formed on the lower surface side of the carriage B104 as explained above. When the air suction opening B123 becomes communicable with a vacuum supply joint B302 provided on main body side of the printer portion B100 when the carriage B104 is moved to the home position so that the air suction opening B123 is connectable with one of cylinder chambers of a cylinder pump B304 of a pump unit B315 via the vacuum supply joint B302 and the vacuum supply tube B303.

On the side of the printer portion B100, a suction cap B310 is provided for capping, when the carriage B104 is moved to the home position, a nozzle face (ink ejection openings forming surface) B403 of the printing head B120 formed with a plurality of ink ejection openings (nozzles) B121 for three groups of Y, M, and C. In the suction cap B310, atmosphere communicating opening B404 is formed. The atmosphere communicating opening B404 can be opened and closed by an atmosphere communication value (not shown).

The suction cap B310 is connected to the other cylinder chamber of the cylinder pump B304 through a suction tube B311. The cylinder pump B304 has three ports respectively connected to the vacuum supply tube B303, the suction tube B311 and a waste liquid tube B312.

In the carriage B104 of FIG. 4, B124 denotes a needle cover, which is moved to a position protecting the lateral hole of the needle B122 from deposition and/or penetration of dirt or dust, by a force of spring when the needle B122 and the joint C105 are not connected. Also, the needle cover B124 releases protection of the needle B122 as pushed upward (in the drawing) against the force of the spring when the needle B122 and the joint C105 are connected together.

On the other hand, as shown in FIG. 4, it is preferred that the gas permeating member B402, provided on the inner surface of the sub-tank B400, and the ink absorbing body B401 are placed in a non-contact arrangement defining a space B412 therebetween. As contacted with ink for a long period of time, vapor-liquid separation performance of the vapor-liquid separation membrane B402 can be lowered. However, in the shown embodiment, by defining the space B412 between the vapor-liquid separating membrane B402 and the ink absorbing body B401 for avoiding direct contact therebetween, ink may not contact with the vapor-liquid separation membrane B402 except upon refilling of ink. Accordingly, lowering of function of the vapor-liquid separating membrane B402 can be prevented. On the other hand, it is preferred that deposition of ink on the inner wall surface of the space B412 (the surface identified by B414, for example) is restricted as much as possible by appropriate surface treatment (such as water repellent treatment).

When ink is supplied from the main tank C103 to the sub-tank B400, the rubber joint C105 and the needle B122, and the vacuum supply joint B302 and the air suction opening B123, respectively, are jointed by the foregoing joint lifter (or joint fork) for supplying ink from the main tank to the sub-tank by sucking air in the sub-tank B400 by the cylinder pump B304 through the vacuum introducing portion B410 and the vapor-liquid separating membrane B402.

After supplying ink to the sub-tank, the rubber joint C105 and the needle B122, and the vacuum supply joint B302 and the air suction opening B123 are separated, respectively. Then, if necessary, the ink in the sub-tank is sucked by the cylinder pump B304 through the suction cap B310. Here, it is preferred to suck the ink at least in the extent of the ink amount residing in the ink needle. In other viewpoint, the ink is passed through the printing head B120, suction is performed in the extent of removing bubble presenting in the vicinity of the nozzle (or possibly admixed with ink), and thereafter, printing operation is performed.

4. “Electric Control System”

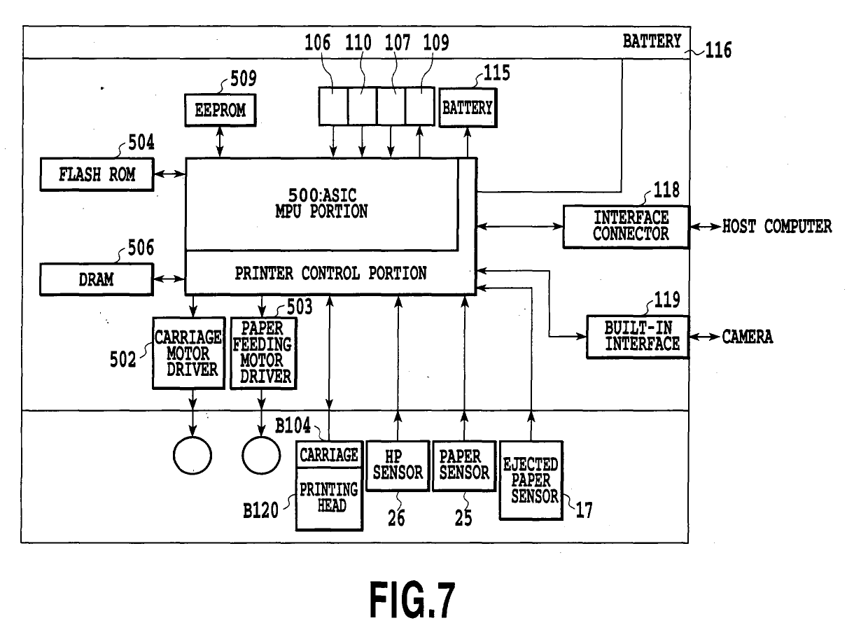

Next, a construction of an electric control system of the shown apparatus will be discussed with reference to FIG. 7.

FIG. 7 is a block diagram of an electrical construction of the present apparatus. In FIG. 7, the reference numeral 500 denotes an ASIC in which MPU portion and a printer-control portion are integrated. 504 denotes a flash ROM recording a program for controlling overall apparatus, 506 denotes DRAM used as work area of ASIC and a buffer of printing image. 509 denotes EEPROM. EEPROM is a rewritable ROM, content of which is not erased even when power is not supplied. In EEPROM 509, setting information done by user during ON state of power source, a used ink amount, ink amount residing in the sub-tank and so forth are written. ASIC further includes a controller for heat pulse generation and generates and transmits a control signal for the printing head for the printing head B120. On the other hand, ASIC performs control of carriage and paper feeding, I/O with other power source, LED and various sensors, exchange of data with camera side, and exchange of data with the computer.

The reference numeral 502 denotes a carriage motor driver for performing driving of the carriage B104, 503 denotes a paper feeding motor driver for driving a paper feeding roller. The carriage motor driver 502 and the paper feeding motor driver 503 perform control of motors by control signals output from ASIC.

The camera portion and the printer portion of the shown apparatus are driven by a battery 116. In the apparatus, another power source 115 is provided to be used for holding date information while the power source of the camera is OFF, measurement and so forth. The reference numeral 106 denotes a power source switch for turning On the power source of the main body, 107 denotes an error release switch, 110 denotes a power lamp and 109 denotes an error lamp.

The reference numeral 118 denotes an interface connector for performing external signal communication with host computer and so forth, for example. The interface connector 118 is connected to the host computer by wire. The reference numeral 119 denotes a built-in interface. Here, the built-in interface 119 performs exchange of data with the camera portion of the printer integrated with the camera.

An HP sensor 26 is a sensor of photo interrupter type for detecting position of the carriage B104. On the other hand, a paper sensor 25 and a paper ejection sensor 17 are contact type sensors depending presence and absence of printing paper in the printing apparatus.

It should be noted that the present invention should not be limited to the embodiments employing a media pack C100, in which an ink pack (main tank) C103 and a printing medium C104) are contained. Namely, it is not necessary that the ink pack (main tank) and the printing medium are contained in the same container. For example, as general printers, it is possible to construct the apparatus to permit insertion of the printing medium from outside of the apparatus, and the main tank may be constructed to be loaded on the apparatus independently. It should be noted that the sub-tank may have a size to contain ink in an amount necessary for printing an image on at least one sheet of printing medium.

(Characteristic features of the Present Invention)

In the present invention, it is taken as one of characteristic features to perform ink drainage process for draining at least a part of remaining ink in the sub-tank before performing pit-in ink supply (also referred to as second pit-in ink supply) for next printing operation. Hereinafter, this feature of the present invention will be discussed in terms of the first to twenty-fourth embodiments.

In the first to nineteenth embodiments, the foregoing ink drainage process is performed at a point of time before initiation of printing. Throughout the disclosure and claims, “point of time before initiation of printing” is, for example, any one of a point of time triggered by turning ON of power source (ON-set of power source), a point of time triggered by reception of a print start signal for initiating printing operation, or a point of time triggered by reception of an initial print start signal for initiating initial printing operation after turning ON of power source.

On the other hand, throughout the disclosure and claims, “left period” is, for example, any one of a period to maintain the power source in OFF state during a period from termination of printing at the preceding time to initiation of printing at the next time, or a period from turning OFF of power source at the preceding time to initiation of printing at the next time, a period from termination of printing at the preceding time to initiation of printing at the next time or a period from completion of recovery process (suction recovery) at the preceding time to initiation of printing at the next time.

(First Embodiment)

The first embodiment is characterized in that it performs ink drainage process for draining of remaining ink in the sub-tank before pit-in ink supply for supplying ink to be used in printing operation to the sub-tank (hereinafter pit-in ink supply for (next) printing operation or pit-in ink supply for (next) printing). Here, particularly, discussion will be given for the case where ink remained in the sub-tank is drained from the printing head by sucking the ink from the printing head in the condition where the printing head is in close contact with the suction cap. In the first embodiment, ink drainage process is performed at a point of time before initiation of printing.

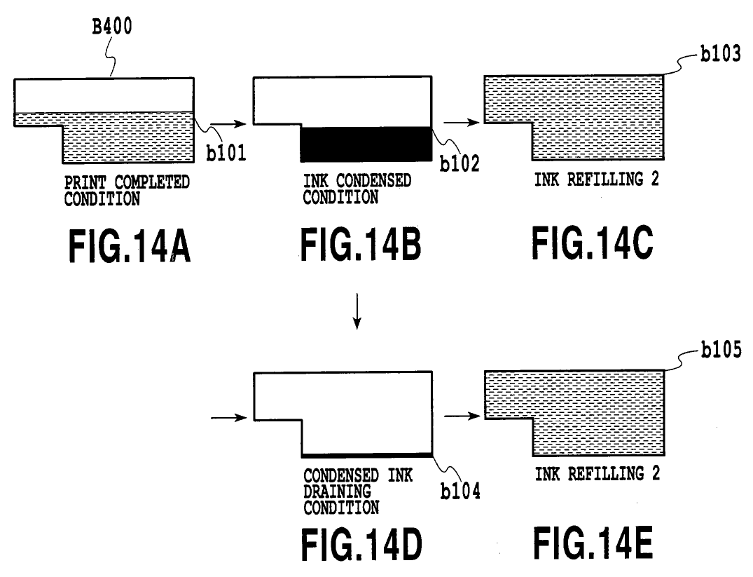

FIGS. 14A to 14E are schematic representations showing a state of an ink in the sub-tank for explaining the first embodiment. FIG. 14A shows a state of the remaining ink in the sub-tank when a printing operation is completed. There is illustrated a state in reduction of ink up to b101 through a printing operation, which originally was in a state where the ink is fully filled up in the sub-tank B400.

As set forth above, since the sub-tank is provided with portions communicated with atmosphere, such as needle and air suction opening, when it is left in a low humidity environment for a long period of time, water component in ink can be evaporated from the sub-tank as water vapor to increase density of coloring agent in the ink for condensation of the internal ink down to b102 (FIG. 14B). When a pit-in ink supply is performed from this condition, even if fresh ink is supplied to make the sub-tank full, newly supplied ink is mixed with condensed ink remaining in relatively large amount, and therefore, the density of the mixed ink becomes higher than that of the initial ink density (FIG. 14C). Then, when printing is performed again with ink in the state of FIG. 14C, the printed density becomes higher than that of the case where printing is performed with the ink of the initial density (density before condensation) to cause fluctuation of color tone upon color printing in subtractive mixing. In other words, color tone of the printed image becomes unnatural, or variation of color tone can be generated between a plurality of sheets of printed images which are adverse influence of the condensed ink.

In contrast to this, in the shown embodiment, as shown in FIG. 14D, condensed ink remained in the sub-tank is drained by suction operation down to the level of b104 at a timing before initiation of printing. Of course, the shown level is an example for the purpose of explanation and the level to drain may be appropriately determined depending upon remaining amount of ink, kind of ink and other factors, and thus should not be limited to the shown example. For improvement of color tone, it is the most effective to drain substantially all amount of remaining condensed ink. However, it is still effective for partly draining the remaining condensed ink. On the other hand, when only a part of remaining condensed ink is drained, it is advantageous in view point of saving of consuming amount of ink.

In FIG. 14D, amount of the remaining condensed ink is quite small. Accordingly, when pit-in ink supply is performed in this state, since amount of fresh ink supplied for the remaining condensed ink is sufficiently large, increase of ink density is caused little, thus permitting a normal printing.

With the first embodiment set forth above, before initiation of printing, fresh ink is supplied to the sub-tank by pit-in ink supply after once draining the remaining condensed ink in the sub-tank left in non-use state for a relatively long period of time. Therefore, printing can be performed with ink having density relatively close to the initial density, and as a result of this, drift of color tone from the original version can be reduced, and also, difference of density of color between plural pages can be reduced.

(Second Embodiment)

The second embodiment is characterized by switching whether draining process for draining remained ink in the sub-tank is to be performed or not on the basis of a time period of leaving the sub-tank in non-use state (for example, an elapsed period from completion of printing operation at the preceding time). More particularly, when the left period is longer than or equal to a predetermined period, draining process for draining the remained ink in the sub-tank is performed, and on the other hand, when the left period is shorter than the predetermined period, control is effected so as not to perform draining process for draining remained ink in the sub-tank.

A reason to perform such a switching control of draining process is summarized as follows. When the left period is relatively short, evaporation of ink in the sub-tank is not progressed in a substantial amount. Accordingly, a significant increase of density as discussed in connection with the first embodiment has not yet caused, and thus, no substantial problem would arise in practice. In such a case, draining process of remaining ink shall not be performed prior to a pit-in ink supply for printing operation. With such an operation, unnecessary consumption of ink could be avoided. In a certain environment, since evaporation speed of ink in the sub-tank can be estimated based on the period of time to be left in a non-use condition, a switching control of the draining process can be made by measuring (time counting) of the left period.

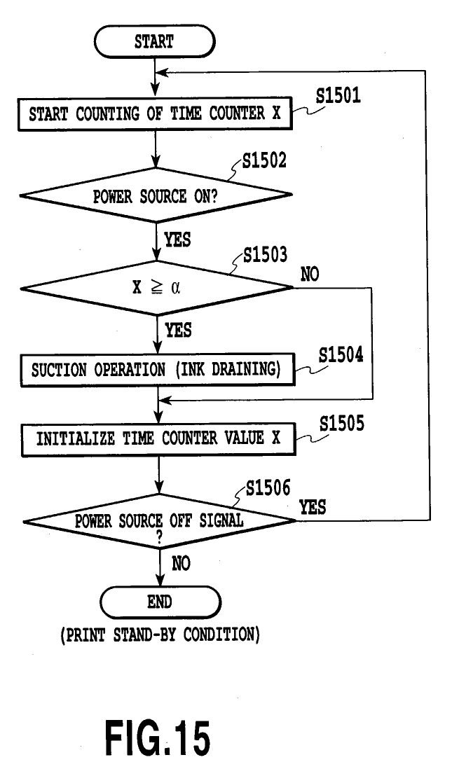

Discussion will be given for the second embodiment of the present invention with reference to the flowchart shown in FIG. 15. At first, a time count X is initialized in response to a power source OFF signal of the printer. At step S1501, counting of the left period is started. In the shown embodiment, the time count value X is incremented each time of elapsing a given period. For example, the time count value X is incremented by one per one second. In the alternative, it is also possible to increment the time count value X by one per one minute, to increment the time count value X by one per one hour or to increment the time count value X by one per day. At step S1502, when the power source is turned ON, the time count value X at this time is compared with a predetermined threshold value a (step S1503).

If the value of the time count X is smaller than the threshold value a at step S1503, a judgment is made that evaporation ink in the sub-tank is not progressed significantly, and the sequence is advanced to step S1505 skipping step S1504. On the other hand, when the value X is greater than or equal to the threshold value α, the process is advanced to step S1504 for reducing degree of condensation of ink. At step S1504, a suction operation is performed to drain ink from the sub-tank. It should be noted that draining amount of ink may be similar to that of the first embodiment. Subsequently, the process is advanced to step S1505 to initialize the time count value X. When the power source OFF signal arrives, the process is returned to step S1501. Otherwise, as long as the state is maintained, the printer is held in a printing stand-by state. It should be noted that, when the printing start signal is input during the printing stand-by state, pit-in ink supply to the sub-tank is performed accordingly, and a subsequent printing is initiated.

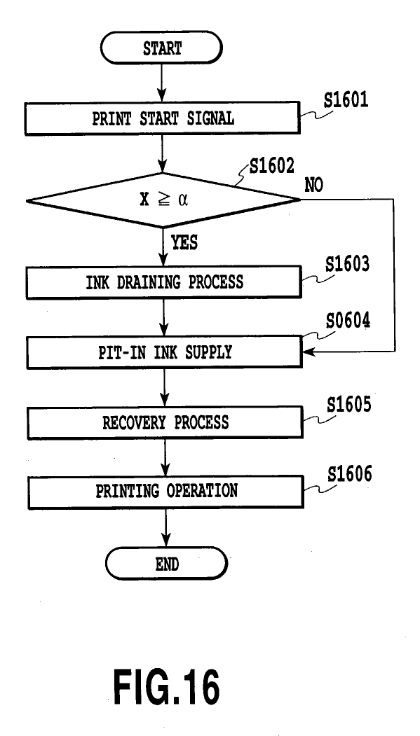

As set forth above, in the embodiment shown in FIG. 15, judgment is made whether ink draining process is to be performed or not before pit-in ink supply for initially performing printing operation after turning ON of power supply. However, it should be appreciated that the point of time to make judgment whether ink draining process is to be performed or not is not limited to the point of time of turning ON of power supply and is only required to be performed before starting printing. For example, judgment may be performed upon receipt of the print start signal. On the other hand, while the time count value X is taken as an elapsed time from turning OFF of the power source in the preceding time in FIG. 15, the period to be measured as a parameter for determining whether draining process is to be performed or not is not limited to the period elapsed from a turning OFF of the power source in the preceding time, but can be a period elapsed from completion of a printing operation. Hereinafter discussion will be given for the case where the judgment point of time whether the ink draining process is to be performed or not is upon reception of the print start signal, and the time count value X is the period elapsed from completion of printing operation in the preceding time with reference to FIG. 16.

A flowchart shown in FIG. 16 will be discussed herein. At first, at step S1601, when the print start signal is received, judgment is made whether the time count value X is greater than or equal to the threshold value α or not at step S1602. Here, the time count value X is the elapsed time from completion of printing operation in the preceding time. If judgment is made that the value X is less than the threshold value α, ink draining process (step S1603) is not performed, and the process is advanced to step S1604. On the other hand, when judgment is made that the value X is greater than or equal to α at step S1602, the ink draining process is performed at step S1603. Subsequently, process is advanced to step S1604. It should be noted that draining amount in the ink draining process may be similar to that of the first embodiment. At step S1604, fresh ink is supplied to the sub-tank by pit-in ink supply, and then, at step S1605, ordinary recovery operation (suction operation) is performed. Thereafter, printing operation is started at step S1606.

It should be noted that the process shown in the flowchart of FIG. 16 may be performed each time of reception of the print signal, or in the alternative, to perform only upon reception of the first print start signal after turning ON of the power source.

With the second embodiment discussed above, when the left period is long, the ink density is estimated as high to perform pit-in ink supply after performing the ink draining process, and on the other hand, when the left period is short, the ink density is estimated as low to perform pit-in ink supply without performing ink draining process. Therefore, in addition to the effect of the first embodiment (reduction of drift of color tone and reduction of difference of density between a plurality of pages), saving of ink consumption can be achieved. In other words, with this embodiment, problems associated with condensation of ink can be reduced while restricting ink draining amount.

(Third Embodiment)

The third embodiment is characterized by realization of further restriction of ink draining amount by controlling ink draining amount with dividing ink draining amounts into a plurality of levels with small step amount when ink draining process in the second embodiment is performed. Specifically, this embodiment is characterized in that it changes the amount of ink drainage depending on the left time.

As set forth above, it becomes necessary to perform ink draining process when degree of ink condensation reaches an extent to cause color tone drift. It is desirable to set ink draining amount in the ink draining process to be constant amount, irrespective of the left period when simplification of control is considered important.

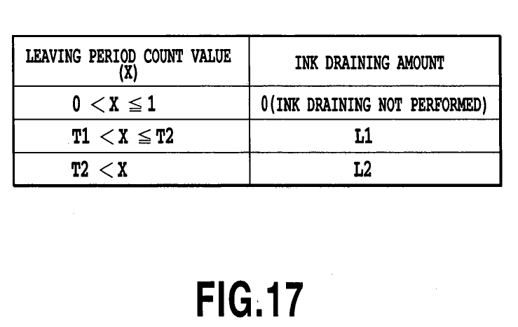

On the other hand, when importance is given for reduction of ink draining amount, it is desirable to differentiate the ink draining amount depending upon the left period. In greater detail, since there is a tendency that a longer left period results in a higher ink condensation degree, the ink draining amount is made greater at longer left period and is made smaller at shorter left period. For example, consideration is given for the case where ink draining amount is controlled in four levels (L1, L2). In this case, as shown in FIG. 17, range of the time count value X (T1<X=<T2, T2<X) and ink draining amount L1, L2 (0<L1<L2) are preliminarily associated, and the ink draining amount is varied depending upon the range, in which the time count value X belongs. By this arrangement, the ink draining amount is gradually increased to L1 and then L2 in association with expansion of the left period. It should be noted that when the time count value X is in a range of 0<X=<T1, ink draining period is not performed as left period is short. In other words, the ink draining amount is 0.

As set forth above, with the third embodiment, since ink draining amount is varied in a plurality of levels depending upon the left period, ink draining amount can be further reduced in comparison with the second embodiment.

(Fourth Embodiment)

When the significant amount of ink has already been reduced during the preceding printing operation (namely, when ink consuming amount upon printing is large), ink amount b101 in FIG. 14A is sufficiently small. Associating with this, remaining condensed ink amount b102 of FIG. 14B is also small. Accordingly, in FIG. 14C, fresh ink (newly supplied ink) is sufficiently supplied to the remaining condensed ink by a pit-in ink supply. Therefore, density of the mixed ink will become not so high. It is thus not always necessary to make the ink draining amount as large as those in the first and second embodiments. Therefore, in the fourth embodiment, in addition to left period of the sub-tank, the ink consuming amount upon printing is taken into account in determining whether ink draining process is to be performed or not and/or controlling the ink draining amount, thus achieving further reduction on ink draining amount.

It should be noted that ink consuming amount upon printing is associated with degree of the ink condensation. When ink consuming amount is large, condensation of ink will not significantly affect for ink density after pit-in ink supply as remaining ink amount is small, and on the other hand, when ink consuming amount is small, condensation of ink will significantly affect ink density after pit-in ink supply as remaining ink amount is large. On the other hand, ink consuming amount upon printing can be acquired by counting ejected dots by means of a dot counter. The dot counter is designed to increase a dot count value Y each time the number of ejected dot increases. For example, the dot count value may be incremented by one at every occasion of ejection of one dot.

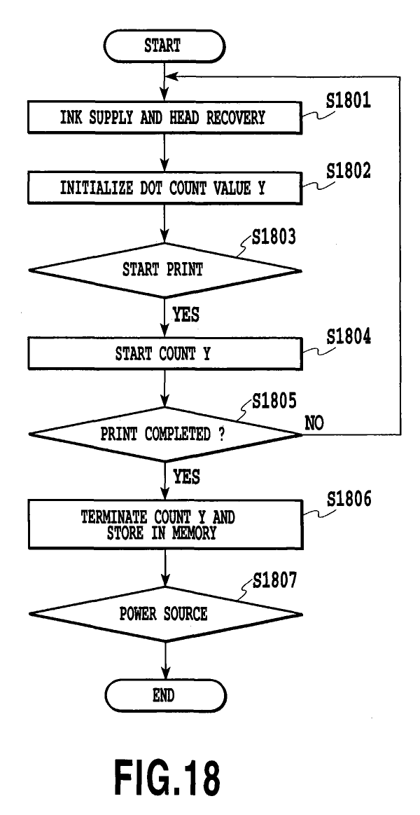

FIG. 18 is a chart showing sequence for obtaining the dot count value. At first, at step S1801 of FIG. 18, ink is supplied from the main tank to the sub-tank by pit-in ink supply method. Subsequently, recovery process for draining ink from the printing head is performed, with suction operation, preparatory ejection and so on. Thereafter, at step S1802, the dot count value Y in the printer is initialized. When the printing is initiated at step S1803, the process is advanced to step S S1804 to start counting by the dot counter. It should be noted that, in the shown embodiment, particular point of time of starting dot count is a time point when feeding of the printing paper to the printer is completed.

Next, the process is advanced to step S S1805 to check whether printing operation is to be terminated or not. Here, when data for next print is not present, printing operation is terminated. On the other hand, when not yet printed data is present, the process returns to step S S1801 to repeat the foregoing processes until all data is printed and no data is present. When printing is completed, the process is advanced to step S1806 to terminate dot count. Here, the count value Y is stored in the memory.

In this embodiment, whether ink draining process is to be performed or not is controlled on the basis of the dot count value Y, and the left period count value X discussed in the second embodiment. In other words, while judgment at step S1503 of FIG. 15 whether ink draining process is to be performed or not is made on the basis of the time count value X, a similar judgment whether ink draining process is to be performed or not is made on the basis of time count value X and the dot count value Y here in the fourth embodiment. In greater detail, using the time count value X and the dot count value Y, a value of X/Y is compared with a predetermined threshold value β, and when the value of X/Y is greater than or equal to β, on an assumption that degree of ink condensation is large, it is determined to perform ink draining process, and when the value of X/Y is smaller than β, on an assumption that degree of ink condensation is small, it is determined not to perform ink draining process. In short, in the fourth embodiment, a process of flowchart of FIG. 15 is carried out with step S1503 replaced with “X/Y>=β”.

With the fourth embodiment set forth above, whether ink draining process is performed or not and the ink draining amount are controlled on the basis of the left period of the sub-tank and the ink consuming amount in printing. Therefore, with reducing the problem associated with condensation of ink, ink draining amount can be further restricted as compared with the second embodiment.

(Fifth Embodiment)

In advance of discussion for the fifth embodiment, common matters in the fifth to fifteenth embodiments will be discussed. In the fifth to fifteenth embodiments, discussion will be given for the case where sub-tank having capacity to store 0.4 ml of ink. However, ink capacity of the sub-tank is of course not limited to 0.4 ml. On the other hand, in the fifth to fifteenth embodiment, discussion has been given with taking “left period” as a period where power source is held OFF between completion of printing at the preceding time and initiation of printing in next time. However, the left period is not limited to the foregoing particular period but can be a period from turning OFF of the power source at the preceding time to initiation of printing in next time, or a period from completion of printing at the preceding time to initiation of printing in next time, for example. On the other hand, in the fifth to fifteenth embodiment, discussion is given for the case where “left period” is managed by number of days and can be managed by hour, minutes or seconds.

The fifth to eighth embodiments are common in terms that control whether ink draining process is to be performed or not before pit-in ink supply for printing at next time is done depending upon at least left period (for example, number of days of leaving). Briefly speaking, small recovery sequence and medium recovery sequence are selectively performed at least depending upon the left period. Definitions of “small recovery sequence” and “medium recovery sequence” will be given later.

In the fifth embodiment, a period of time where the printer is left in non-use state (left state) is calculated. When the left period is longer than or equal to a predetermined period, ink draining process is performed for draining all amount (substantially all amount) of flowable ink in the sub-tank. On the other hand, when the left period is shorter than the predetermined period, ink draining process is not performed. More particularly, when the left period is long, ink draining process is performed before pit-in ink supply for printing operation. On the other hand, when the left period is short, ink draining process is not performed before pit-in ink supply for printing operation. In short, based on the left period, control is performed for selectively performing medium recovery sequence and small recovery sequence.

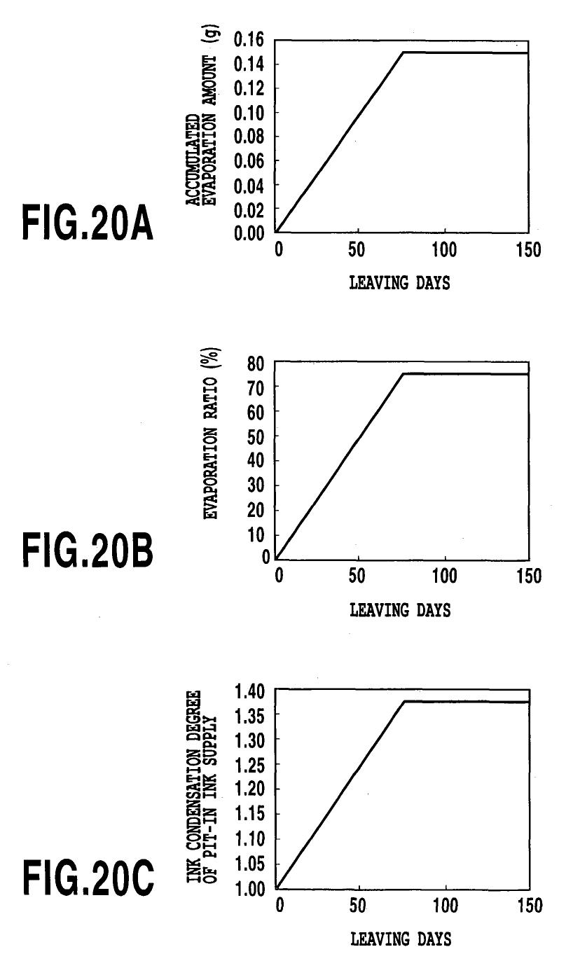

FIGS. 20A to 20C are graphic charts for explaining degree of evaporation of remained ink in the sub-tank and influence thereof in the case where ink in the sub-tank is left. In FIG. 20A, horizontal axis presents left days and vertical axis is accumulated evaporation amount G. Ink remaining amount in the sub-tank before start of being left is 0.2 ml (=200 μl) similarly to the prior art. In other words, while ink capacity of the sub-tank for each color of ink to be filled is 0.4 ml, it is assumed that being-left-state is started in the condition wherein ink is consumed to be about half and 0.2 ml of each color is left.

The fifth embodiment uses ink containing 5% by weight of coloring agent, 20% by weight of non-volatile solvent (7% by weight of ethylene glycol, 12% by weight of diethylene glycol, about 1% of surface active agent), and remaining 75% by weight of volatile solvent (72.5% by weight of water, 2.5% by weight of isopropyl alcohol). Since volatile component is 75% by weight, evaporative amount becomes 200 μl×0.75=150 μl. Assuming that evaporation speed is 2 μl/day similarly to the prior art, volatile component is evaporated substantially completely within 75 days. The point is inflection point in FIG. 20A. It should be noted that the values shown in FIGS. 20A to 20C are calculated value, the inflection point is clear. In practice, however, evaporation becomes moderate before the inflection point to saturate with smooth curve. For the purpose of disclosure, discussion will be given with reference to the graph of the calculated value.

In FIG. 20B, the horizontal axis represents left days and the vertical axis represents a ratio of evaporated ink weight relative to initially remaining ink weight (weight of remaining ink before start of being-left state).

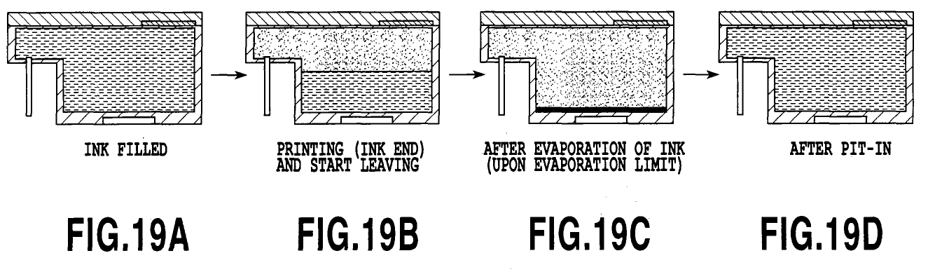

Things explained heretofore are the same as those discussed in terms of the prior art, and point of an essentially complete condensation of ink in the sub-tank is inflection point in FIG. 20C. Here, from the state of the sub-tank illustrated in FIG. 20C, when the user performs printing (namely printing after being left), in the prior art, ink is, at first, supplied into the sub-tank by pit-in ink supply method. The resulting state is illustrated in FIG. 19D. While supplied ink is fresh ink, density of ink in the sub-tank becomes higher than that of fresh ink, since remained ink in the printing operation in the preceding time is remained in condensed condition. Calculated condensation degree is shown in FIG. 20C. Condensation degree of 1.1 times of ink density of fresh ink (namely, ratio of coloring agent derived by amount of coloring agent/total ink amount, 5% in the shown embodiment) means that ink having 5.5% of ink density of coloring agent versus initial density (5%) of ink.

In FIG. 20C, horizontal axis represents left days. For example, when pit-in ink supply is performed for printing after being left for 50 days from the state of the sub-tank of the remaining ink set forth above, fresh ink is supplied to the sub-tank and is admixed with the remaining condensed ink to form ink having a density of 1.25 times of the initial ink density.

As a result of study made by the inventors, it has been found that, concerning ink used in the fifth embodiment, when condensation degree of ink is smaller than or equal to 1.15 times, ΔE (color difference) in CIE1976 L*a*b color specification system is less than or equal to 5 and is preferable, and when condensation degree of ink is smaller than or equal to 1.25 times, ΔE is about 10 which is on an allowable limit, and further greater condensation degree is not preferable. “An allowable limit” used here represents a limit value where difference of color texture relative to particular color can be perceived but is allowable for the case of printing ordinary photograph printing mainly premised as application of the printer of the present invention (photograph printer specialized for digital camera, for example). Of course, this value may be differentiated depending upon application of the printer.

In the present invention, even when the power source of the main body is held OFF, ASIC500 is periodically actuated using an internal battery 515 to count up a period of time in which the power source of the printer is held OFF (namely left period) and memorize it in EEPROM 509. Then, at next printing, when the value of the left period stored in EEPROM is greater than or equal to a predetermined value (here longer than or equal to 50 days), after initially draining all amount of flowable remaining condensed ink in the sub-tank, ink is supplied into the sub-tank by pit-in ink supply for performing printing after predetermined recovery operation or the like. Therefore, it becomes possible to maintain a total ink condensation degree in the sub-tank after supplying ink by pit-in ink supply not exceeding 1.25 times, thus enabling to reduce difference of color texture of the image in printing operation in next time after being left.

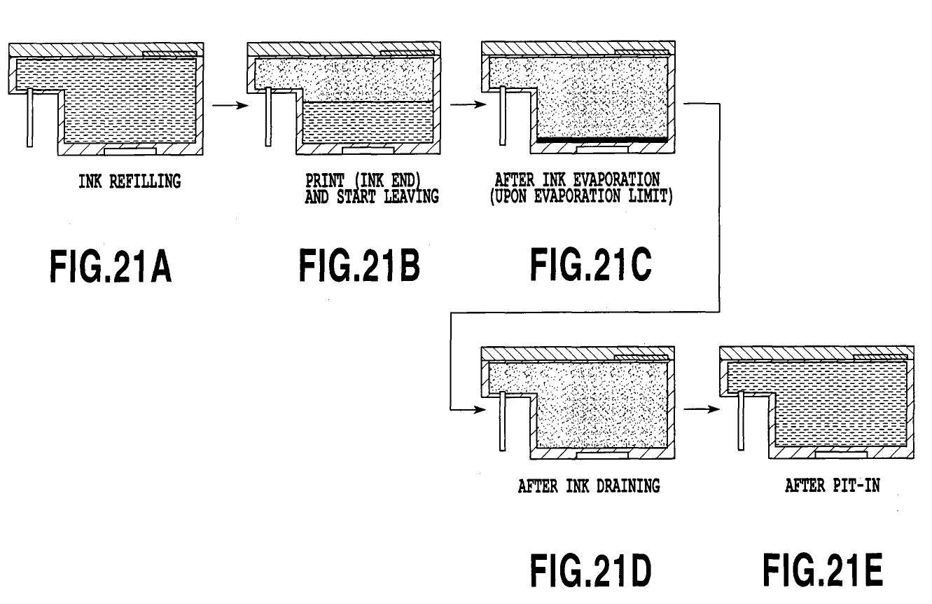

FIGS. 21A to 21E are schematic representations for explaining effects of the shown embodiment in relation to the prior art shown in FIGS. 19A to 19D. FIGS. 21A to 21C are the same as FIGS. 19A to 19C, However, as shown in FIG. 21D, in the shown embodiment, by detecting that the sub-tank is left for a predetermined period in non-use state, suction operation is performed to drain all amount of flowable remaining condensed ink in the sub-tank as much as possible after being left and before printing.

Suction for draining flowable remaining ink in the sub-tank is performed by applying all negative pressure generated by full stroke of a cylinder pump B304 to ejection nozzles B121 of the printing head B120 and maintaining the negative pressure with maintaining an atmosphere communication valve for communicating the cap B310 with atmosphere for a given period (here 20 seconds) in closed condition for forced suction. The negative pressure to be generated may be variable depending upon initial volume in mechanism and stroke of the cylinder pump, and is preferred to be greater than or equal to 50 kPa for quickly draining ink in the sub-tank. Of course, capacity of the cylinder pump is greater than the capacity of the sub-tank. Namely, the cylinder pump is designed for continuously applying negative pressure of 50 kPa or more for several tens seconds for forced suction.

The sub-tank is communicated with atmosphere through the air suction opening, the vapor-liquid separation membrane and the air chamber, and is also communicated with atmosphere even by opening the needle B122 without connecting with the joint C105. By performing suction set forth above in the state of communication with atmosphere, air is sucked from the air suction opening or the needle to suck ink in the sub-tank into the cylinder pump through the nozzles. Since ink is supplied in the sub-tank by performing pit-in ink supply as shown in FIG. 21E after draining ink in the sub-tank as shown in FIG. 21D, increase of ink density due to remaining ink of printing in preceding time can be prevented, thus enabling to perform printing in the state of substantially fresh ink even after being left.

It should be noted that, assuming that ink amount to be contained in the sub-tank is V (ml), ink remaining amount upon printing in the preceding time is v (ml), evaporation speed is w (μl/day), and left days is T (days), ink amount to be supplied by pit-in ink supply in next time becomes (V−v)+w·T. Therefore, total ink density a″ contained in ink remained at the preceding time may be expressed as follows, assuming that initial ink density is a and remained ink density upon printing at the preceding time is also a:

$${a}^{″} = \frac{( ( V - v ) + wT ) a + va}{V} = a ( 1 + \frac{wT}{V} ) \qquad ( 1 )$$

In other words, ink condensation degree R″ becomes a″/a=1+(wT/V), and in simplified process, it does not depend on ink remaining amount upon printing at the preceding time. On the other hand, number of days T where the ink condensation degree becomes greater than or equal to 1.25 times is determined by ((1.25−1)·V)/w. In the fifth embodiment, when the left period exceeds this T (days), a control is done to perform pit-in ink supply after draining ink in the sub-tank.

As set forth in the prior art, evaporation speed w is the evaporation speed in an environmental condition where evaporation is most significant among operation environments of the printer. It should be noted that evaporation speed experimentally derived under 30° C. of atmospheric temperature and 10% of relative humidity, is used.

By performing control of the ink draining process depending upon the left period (for example, left days), there was no significant variation in ink density in the sub-tank after pit-in ink supply, and density of image is natural. Furthermore, even when the same image is printed continuously, printed output were without visually perceptive density difference between the printed images.

With the fifth embodiment set forth above, since whether ink draining process before pit-in ink supply is to be performed or not is controlled depending upon the left period (for example, left days), it becomes possible to reduce influence of ink condensation with restricting ink draining amount.

(Sixth Embodiment)

In the sixth embodiment, for determining whether ink draining process is to be performed or not, consideration is given not only for the left days but also for an amount of remaining ink (ink remaining amount) in the sub-tank at a point of time of completion of printing in the preceding time. In short, on the basis of the ink remaining amount in the sub-tank at the completion of printing and the left days, control whether the ink draining process is to be performed or not is performed before pit-in ink supply. Simply stating, on the basis of ink remaining amount in the sub-tank after completion of printing at the preceding time and the left period, control is performed whether medium recovery sequence is performed or small recovery sequence is performed. It should be noted that “small recovery sequence” and “medium recovery sequence” will be defined later.

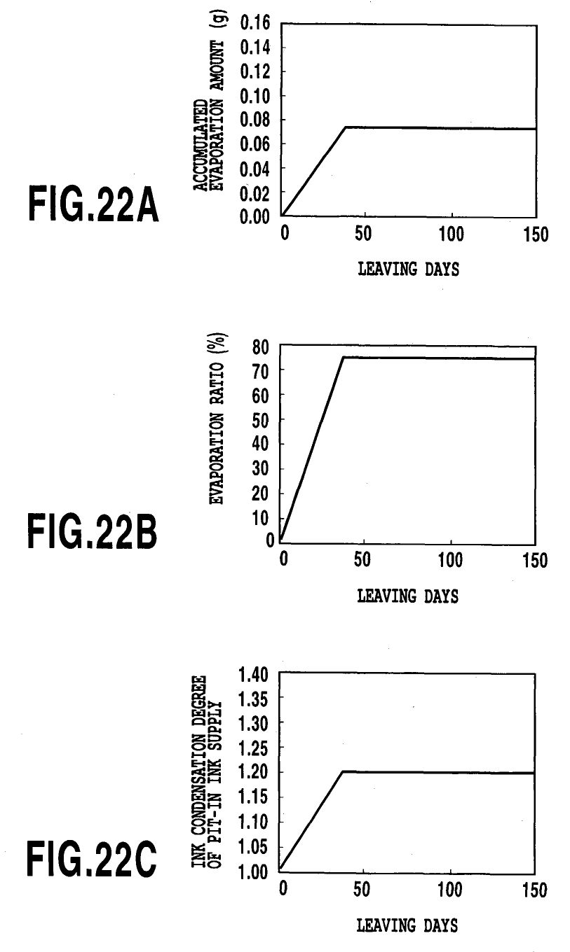

FIGS. 22A to 22C are graphic charts corresponding to FIGS. 20A to 20C of the case where being left state is started in the state where the ink remaining amount in the sub-tank is 100 μl. Incidentally, the ink remaining amount of FIGS. 20A to 20C is 200 ml. An accumulated evaporation amount of FIG. 22A is increased with the same gradient as FIG. 20A initially. However, since ink remaining amount is smaller than that of the case of FIG. 20A, evaporation limit is reached at a time point earlier than that of FIG. 20A. On the other hand, as shown FIG. 22B, since the initial remaining amount is smaller, gradient of evaporation ratio is greater than that of FIG. 20B to reach the evaporation limit at a time point (particularly about 30 days) earlier than 50 days.

The reason of substantial difference of influence of evaporation depends upon initial ink remaining amount, and is the problem specific to the pit-in ink supply method having small sub-tank, caused due to small capacity of the sub-tank. It should be pointed out that, as shown in FIG. 22C, even when the evaporation limit is reached, and when fresh ink is supplied to such condensed ink, the ink condensation degree in total may not reach 1.25 times taken as threshold value in the fifth embodiment since evaporation stops. Therefore, no problem is arisen in terms of variation of color texture (density becoming higher) of the images due to condensation of ink. Accordingly, as in the fifth embodiment, even when the evaporation limit is reached, no problem will arise with the fifth embodiment if viscosity of the remaining condensed ink is relatively low (slightly higher than 100 mPas in the ink of the fifth embodiment).

However, for example when the solvent having high viscosity, such as glycerin, or when solid component, such as urea or the like is used, the viscosity of the remaining condensed ink as reached evaporation limit is greater than or equal to about 400 mpas. Then viscosity becomes 200 times or more of the normal ink viscosity, thus causing difficulty in normal recovery.

Ink composition can be modified for various reasons, such as for solubility of the coloring agent to the solvent and presence/absence of possibility of causing deterioration in printing head. The sixth embodiment uses ink composed of 5% by weight of coloring agent, 20% by weight of non-volatile solvent (8% by weight of glycerin, 6% by weight of diethylene glycol, 5% by weight of urea, about 1% of surface active agent), and remaining 75% by weight of volatile solvent (72.5% by weight of water, 2.5% by weight of isopropyl alcohol).

Therefore, viscosity of remaining condensed ink reaching the evaporation limit is different from the fifth embodiment. Specifically, viscosity of ink becomes greater than or equal to 400 mPas or more to reach two hundred times or more of the normal ink viscosity. Normal recovery becomes difficult for ink of such a high density. However, in the case where the sub-tank is left for 30 days or more to reach the evaporation limit, if ink draining process is performed to drain all amount of ink in the sub-tank before pit-in ink supply as in the fifth embodiment, when being left starts in the state where a relatively large amount of ink is remaining in the sub-tank (i.e. as in the example of FIGS. 20A to 20C), ink in the sub-tank is drained as left for 30 days or more to needlessly increase ink consuming amount.

Since the present invention is premised to relatively small photograph printer or the like, capacity of ink storage is naturally not large. Accordingly, when ink consuming amount is large, running cost per one sheet of printing becomes high. For this reason, in the sixth embodiment, in order to adapt to difference of ink viscosity after being left due to difference of ink remaining amount in the sub-tank after printing in the preceding time, ink draining process before pit-in ink supply is controlled in consideration of not only the left period but also ink remaining amount in the sub-tank upon completion of printing of the preceding time. In other words, in the sixth embodiment, ink remaining amount in the sub-tank at the completion of printing of the preceding time is stored in EEPROM in the main body, and further, as discussed in the fifth embodiment, the left period (left days in this embodiment) is counted up and stored in EEPROM. Then, on the basis of the ink remaining amount at the completion of printing of the preceding time and the left period, recovery sequences before printing in the next time are switched.

Particularly, on the basis of the ink remaining amount (v) at the completion of printing at the preceding time and left days (T), the recovery sequences are switched as shown in the following table. In the table, sign “-” represents that ink draining process (process to drain all amount of flowable ink in the sub-tank) is not performed before pit-in ink supply, and pit-in ink supply is performed and subsequently normal recovery process (suction recovery operation and preparatory ejection operation) are performed. In other words, “small recovery sequence” defined later is performed. On the other hand, sign “o” represents that the ink draining process is performed before pit-in ink supply, pit-in ink supply is performed, and subsequently normal recovery process is performed. Namely, “medium recovery sequence” defined later is performed.

TABLE 1

| | Left days | | | | |
|---|---|---|---|---|---|
| | | 25 => T | 30 =< T | 35 =< T | |
| | T < 25 | <30 | <35 | <40 | 40 =< T |
| Ink | | | | | |
| remaining | | | | | |
| Amount | | | | | |
| V < 100 μl | — | o | o | o | o |
| 100 =< V < 200 | — | — | o | o | o |
| μl | | | | | |
| 200 =< V < 300 | — | — | — | o | o |
| μl | | | | | |
| 300 =< V < 400 | — | — | — | — | o |
| μl | | | | | |

Here, discussion will be given for means for precisely detecting ink amount remained in the sub-tank after printing. At first, since ink amount to be stored in the sub-tank and ink amount to be drained by recovery operation are fixed values, they are stored in ROM 504 or EEPROM 509. It should be noted that since there is some tolerance in the ink amount to be stored in the sub-tank or the ink amount to be drained by recovery operation between apparatus bodies, precision in detection of ink remaining amount can be further enhanced by correcting such tolerance.

Next, ASIC500 has a function of integrating ink ejection amount per one ink droplet ejected by ejecting operation (hereinafter referred to as dot counter). Ink remaining amount in the sub-tank can be derived by subtracting ink amount drained by recovery operation as well as ink consuming amount derived by number of ink droplet counted by the dot counter×ejection amount in one droplet from the ink amount capable to be stored in the sub-tank. Here, since the capacity of the sub-tank is set at 0.4 ml, precision in the extent of 0.0001 ml is preferred as precision in detection of ink remaining amount. It should be noted that ink amount of one ink droplet may slightly fluctuate per printing head, precision can be further enhanced by correction with taking such fluctuation into account.

Then, control of recovery operation was performed depending upon the left period (for example, left days) and ink remaining amount in the sub-tank at completion of printing at the preceding time. As a result, in addition to the effects achieved by the fifth embodiment, occurrence of ejection failure due to ink of increased viscosity could be eliminated or reduced even when ink of this embodiment was used, and furthermore ink draining amount by ink draining process would not become excessively large.

With the sixth embodiment set forth above, control of recovery operation depending upon the left period (for example, left days) and ink remaining amount in the sub-tank at completion of printing at the preceding time was performed. Therefore, problems associated with condensation of ink can be restricted with restricting ink draining amount.

(Seventh Embodiment)

Flowable ink in the sub-tank set forth in connection with the fifth embodiment does not include ink that cannot be drained for not being flown with air as wetting sponge of PP fibers of the sub-tank, or depositing or being trapped on a surface layer on the inner surface of a frame body and corner portions.

Amount of not flowable ink depends on the structure of the sub-tank, and particularly on density and diameter of fibers of sponge in the sub-tank. In the seventh embodiment, when the sponge having a density of 0.4 g/cm³ and formed with PP fibers of 6 deniers was used, amount of non-flowable ink (hereinafter referred to dead ink) in the sub-tank having capacity for storing 0.4 ml of ink, was 0.06 ml. Accordingly, in practice, remained ink cannot be drained completely after printing at the preceding time unlike the one shown in FIG. 21D. As a result, accurately, ink density of FIG. 21E is slightly higher than fresh ink. On the other hand, evaporation amount wT does not increase infinitely depending upon left days, and evaporation amount increases according to increase of left days until the evaporation limit is reached and evaporation is stopped after reaching the evaporation limit (accurately, solvent component difficult to evaporate may continue to evaporate slightly). Taking these elements into account, the seventh embodiment controls recovery operation more precisely and thereby enabling to avoid unnecessary consumption of ink, as will be discussed hereinafter.

In this seventh embodiment, ink remaining amount in the sub-tank and ink condensation degree in the sub-tank are constantly controlled. Cases to vary ink remaining amount in the sub-tank include the following four different situations: (1) ink is supplied to the sub-tank by pit-in ink supply as an event, (2) ink is consumed by suction recovery, preparatory ejection or printing, (3) ink in the sub-tank is evaporated by being left and (4) the process for draining all amount of flowable ink in the sub-tank, which process is unique to the present invention (ink draining process), is performed. On the other hand, condensation rate of ink in the sub-tank varies only in the case of (1) and (3). Here, parameters used in calculations are defined as shown in the following table 2. It should be noted that while the fill-up amount of the sub-tank is defined as V and ink remaining amount in the sub-tank is defined as v in the fifth embodiment, ink remaining amount in the sub-tank is defined as V and consumed amount (=sucked amount+ejected amount) is defined as v in the seventh embodiment.

TABLE 2

| | Parameter | Unit | |
|---|---|---|---|
| Value before Event | Ink reamining amount | V | μl |
| | in Sub-tank | | |
| | Ink Condensation | R | Times |
| | Degree in Sub-tank | | |
| Evaporation | Left days | T | Days |
| Relation ship upon | | | |
| Leaving | Evaporation rate | 2.0 | μl/day |
| Value related to Ink | Rate of Non-Volatile | α | — |
| Composition | Component | | (ex. |
| | | | 0.25) |
| Value related to Ink | Ink Consumption Amount | v | μl |
| Consumption | | | |
| Value related to | Fill-up Amount | 400 | μl |
| Sub-Tank | Dead Ink Amount | 60 | μl |

Here, rate of non-volatile component is a ratio of non-volatile component (coloring agent+solvent difficult to evaporate) in ink. For example, in the fifth and sixth embodiments, rate of non-volatile component is 25%=0.25.

After the said events of (1) to (4), ink remaining amount V in the sub-tank and ink condensation degree R in the sub-tank may be expressed as shown in the following table 3. V and R on right side in relational expressions are the current ink remaining amount in the sub-tank and ink condensation degree in the sub-tank, and V and R on left side are the ink remaining amount in the sub-tank after respective events and ink condensation degree in the sub-tank.

TABLE 3

| | Ink Remaining | Ink Condensation |
|---|---|---|
| Event | Amount in Sub-Tank | Degree in Sub-Tank |
| After Pit-in Ink | o | o |
| Supply | V = 400 μl | R = }(400 − V) + V × |
| | | R}/400 |
| After Ink | o | − |
| Consuming | V = V − v | (not varied) |
| Operation | | |
| After being left | o | o |
| (After | V = Max (V × (α · R), | V = R × [V/Max (V × |
| Evaporation) | V − 2.0 · T) | (α × R), T − 2.0 · T)] |
| After Draining All | o | − |
| | V = 60 μl | (not varied) |

Varied = “o”/Not Varied “−”

It is obvious that ink remaining amount after pit-in ink supply is 400 μl upon filled up, and that ink remaining amount after draining all amount is 60 μl. Ink remaining amount after ink consuming operation (after printing) becomes an amount subtracting the consumed ink amount v calculated using the dot counting function as discussed in connection with the sixth embodiment from the current ink remaining amount V (V−v). Concerning ink remaining amount after being left, since ink condensation degree before being left is R, rate of non-volatile component before being left becomes α×R, and the value derived by multiplying the ink remaining amount V before being left by α×R is amount of non-volatile component (V×α×R) contained in the ink before being left. On the other hand, as ink is evaporated by 2.0 μl per day, remaining amount after being left for T days becomes V−2.0×T. Greater one of these (namely, not become smaller than the evaporation limit) is the ink remaining amount in the sub-tank with taking evaporation after being left into consideration.

On the other hand, concerning the ink condensation degree R, when volume becomes half of the initial volume by evaporation, condensation degree is doubled. Therefore, a reciprocal number of variation of volume is the ink condensation degree in the sub-tank with taking evaporation after being left into account. Furthermore, since when the current ink remaining amount in the sub-tank is V, the ink amount to be supplied by pit-in ink supply is 400−V, the ink condensation degree after pit-in ink supply may be a value derived by adding a product of the current ink amount in the sub-tank and the ink condensation degree to 400−V and then dividing by the fill-up amount of the sub-tank. In this process, by updating V and R before and after each event, condition in the ink in the sub-tank is monitored constantly.

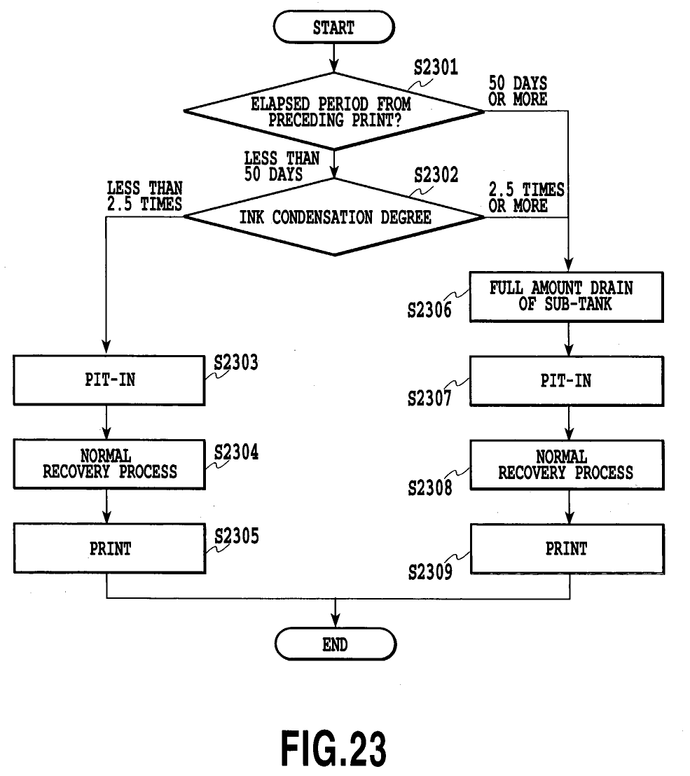

Then, in the seventh embodiment, as shown in flowchart of FIG. 23, similarly to the fifth embodiment, when the left period (elapsed time after completion of printing at the preceding time) is longer than or equal to the predetermined period (here longer than or equal to 50 days), all amount of flowable ink is drained (full amount drainage) among the remaining ink in the sub-tank, then pit-in ink supply is performed, and subsequently, normal recovery process (suction operation) and printing process are performed. In conjunction therewith, even when the left period is shorter than the predetermined period (here, shorter than 50 days), if the ink condensation degree in the sub-tank is greater than or equal to a predetermined value (here, 2.5 times or more), the same process is performed as the process in the case where the left period is longer than or equal to 50 days. On the other hand, when the left period is shorter than the predetermined period and the ink condensation degree is smaller than the predetermined value, pit-in ink supply is performed without performing full amount drainage for draining all amount of ink in the sub-tank, and subsequently, normal recovery process (suction operation) and printing process are performed. Briefly-speaking, small recovery sequence and medium recovery sequence are selectively performed depending at least upon the left period and the ink condensation degree. Definition of “small recovery sequence” and “medium recovery sequence” will be given later.

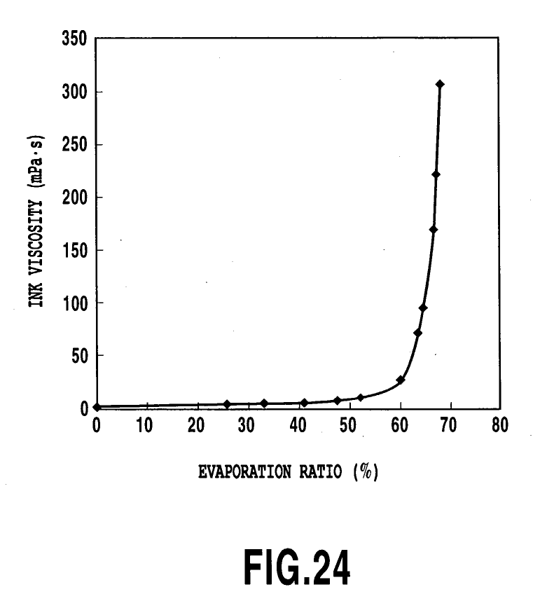

It should be noted that ink used in the shown embodiment is similar to the one used in the sixth embodiment. However, a relationship between evaporation ratio and viscosity of ink is shown in FIG. 24. 2.5 times of condensation ratio means that the volume becomes 40% of initial volume. Therefore, it can be converted as 60% of evaporation ratio. Ink viscosity is swiftly increased when evaporation ratio exceeds 60%. In the seventh embodiment, 2.5 times of condensation ratio is taken as the threshold value, and foregoing ink draining process is performed even when the left period is shorter than the predetermined period if the condensation degree is greater than the predetermined value.

In this seventh embodiment, since recovery method is controlled depending upon viscosity of the ink (or evaporation ratio correlated with the viscosity or ink condensation ratio), precise measurement can be taken to permit further reduction of ink consuming amount.

As set forth above, on the basis of the left days, the ink remaining amount in the sub-tank at the completion of printing at the preceding time and ink condensation degree in the sub-tank at the completion of printing at the preceding time, the ink condensation degree in the sub-tank of printing at the next time is calculated. Then, recovery control is differentiated depending upon the ink condensation degree and the left days to achieve effect achieved in the fifth and sixth embodiments. In addition, ink consuming amount can be further reduced. As a result, it becomes possible to provide the printer which achieves low running cost per sheet.

(Eighth Embodiment)

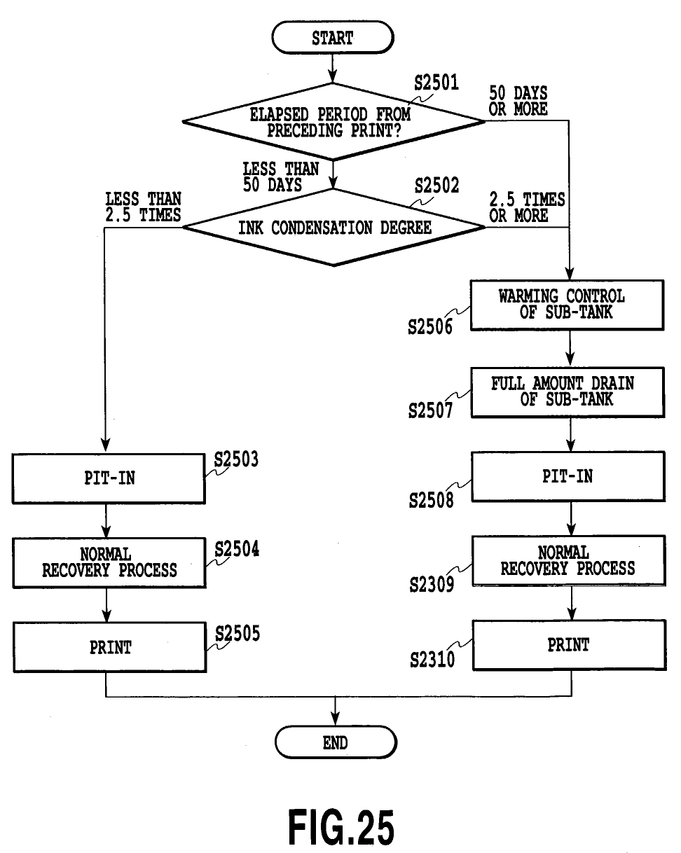

The eighth embodiment is characterized by warming of the printing head prior to ink draining process for draining ink from the sub-tank (for example, full amount drainage process), and rest part of the embodiment is similar to the first to seventh embodiments and discussion will be eliminated for avoiding redundant disclosure for simplification in order to facilitate clear understanding of the present invention. In the shown embodiment, as shown by flowchart in FIG. 25, ink draining process (full amount drainage process) in the first to seventh embodiments is performed in the condition where ink in the printing head and sub-tank is warmed by warming process of the printing head.

In the printing head, a heater for ink ejection is provided. A current in a magnitude not to cause ejection of ink is applied to the heater (hereinafter referred to “apply warming pulse”) to warm ink around the nozzles of the printing head. The warming pulse preferably has amplitude half or less of a pulse for generating bubble. In the shown embodiment, the warming pulse is 0.3 μsec whereas the bubbling pulse is 0.7 μsec. When the warning pulse is applied for a long period, the apparatus can warm ink not only in the vicinity of the nozzles of the printing head but also in the ink passage and further in the sub-tank. It should be noted that temperature control is performed by reading output of diode sensor or the like provided in the printing head.

By applying the warming pulse, control is performed so that the head temperature reaches 50° C. in the eighth embodiment. On the other hand, control is performed to maintain 50° C. as target temperature for 30 seconds after reaching the head temperature at 50° C. Ink temperature in the vicinity of the nozzles reaches substantially the target temperature after 30 seconds. Thus, while viscosity of ink upon reaching evaporation limit in the fifth embodiment is 400 mPas at normal temperature (25° C.), the shown embodiment may lower viscosity of ink down to several tens mpas.

By warming ink of increased viscosity by evaporation after being left, ink viscosity can be lowered to facilitate full amount drainage of the ink in the sub-tank. By warming, reliability can be improved even when ink having quite high viscosity at evaporation limit (such as ink containing large amount of glycerin).

(Ninth Embodiment)

In the first to eighth embodiments, discussion is given for performing ink draining process (for example, full amount drainage process) before pit-in ink supply for printing operation. However, in the ninth embodiment, in advance of ink draining process, pit-in ink supply is performed in order to facilitate ink drainage. Reason to perform ink draining process further before pit-in ink supply will be discussed hereinafter.

As discussed in connection with the first to eighth embodiments, by performing ink draining process before pit-in ink supply for printing operation, remaining condensed ink in the sub-tank is basically drained. Accordingly, basically, ink draining process sequence in the first to eighth embodiments will be sufficient. However, even when ink draining process is performed, it is possible that intended amount of the remaining condensed ink cannot be drained. For example, even when attempt is made to drain full amount of remaining condensed ink, it is possible that full amount of ink cannot be drained. It is predicted that this is caused due to the following phenomenon.

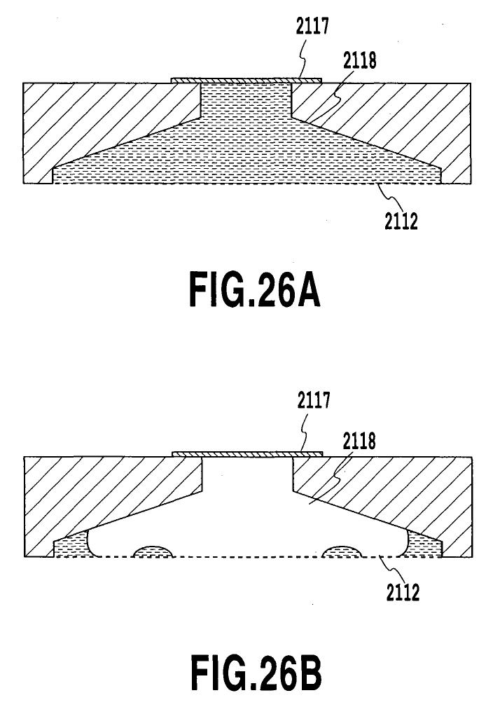

FIG. 26A is a detailed representation of the printing head illustrating the ink passage and the nozzle. The reference numeral 2117 denotes a SUS filter provided an ink inlet opening from the sub-tank. 2118 denotes an ink passage and 2112 denotes nozzle array. For example, it is assumed that ink with high viscosity is filled in the ink passage after being left as shown in FIG. 26A. Here, ink with increased viscosity is quite difficult to flow even when a strong ink draining process (for example, drawing ink at a large negative pressure for a long period) is performed. On the other hand, there are nozzles easily flow ink and nozzles difficult to flow ink due to tolerance in nozzle diameters in production, tolerance in shapes or a little tolerance in evaporation ratios between respective nozzles. Once ink start to flow in a nozzle, ink in the vicinity thereof flows to facilitate draining of ink through the nozzles therearound, whereas nozzle through which ink does not flow in relatively initial stage, is difficult to perform drainage. Diagrammatically illustrating, as shown in FIG. 26B, remaining condensed ink (ink with increased viscosity) may be remained slightly. It should be noted that this phenomenon is caused with higher possibility at end portions of nozzle array.

Even when fresh, non-evaporated ink is filled into the ink passage 2118 by performing pit-in ink supply and subsequent normal recovery operation in the state where ink with increased viscosity is remained, since the ink with increased viscosity cannot be solved quickly, ink with increased viscosity may reside in the vicinity of ejection openings to possibly cause ejection failure. Reason why the ink with increased viscosity cannot be sucked by normal recovery operation after pit-in ink supply is difference of viscosity between non-evaporated ink and ink with increased viscosity. Since ink with increased viscosity is difficult to flow even by performing suction recovery, and only non-evaporated ink with lower viscosity flows to be sucked through the nozzle.

As set forth above, in the pit-in ink supply method, increase of viscosity due to evaporation of ink is significant, even when the foregoing ink draining process is performed, ink with increased viscosity after being left for a long period of time cannot be drained, or even when the ink with increased viscosity can be drained, draining can be insufficient thereby possibly causing ejection failure. Accordingly, it is desired to improve draining performance of remaining condensed ink (ink with increased viscosity) by ink draining process.

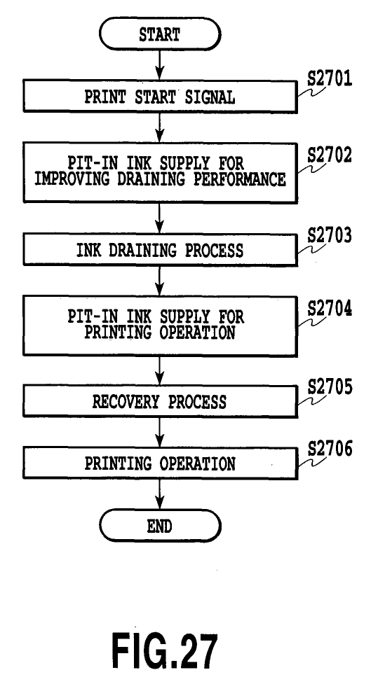

Therefore, with the ninth embodiment, pit-in ink supply is performed for facilitating ink ejection process is performed before performing ink draining process (for example, full amount draining process) in advance of pit-in ink supply process for printing operation as shown in FIG. 27. Particularly, when print start signal is received at step S2701 of flowchart of FIG. 27, pit-in ink supply is performed for the purpose of improvement of draining performance of the ink with increased viscosity (remaining condensed ink) at step S2702. Next, at step S2703, ink draining process (for example, full amount draining process) for draining ink from the sub-tank is performed. Subsequently, the process is advanced to step S2704 to perform pit-in ink supply for printing operation. Subsequently, at step S2705, normal recovery process is performed, and at step 2706, printing operation is started.

As set forth above, with the ninth embodiment, pit-in ink supply is performed before ink draining process to increase solubility of the ink with increased viscosity by mixing fresh ink supplied in the pit-in ink supply so that ink with increased viscosity can be solved and thus conditioned to be easily drained during ink draining process. Accordingly, possibility of draining of the ink with increased viscosity by the ink draining process before pit-in ink supply for printing operation becomes high. As a result, in comparison with the first to eighth embodiment, possibility of occurrence of ejection failure can be reduced.

(Tenth Embodiment)

The tenth embodiment controls whether pit-in ink supply for improving ink draining performance and ink draining process are to be performed in advance of pit-in ink supply for next printing operation, at least depending upon left period (for example, left days). This feature is common to the eleventh to fourteenth embodiment discussed later. Briefly, small recovery sequence and medium recovery sequence are selectively performed at least depending upon the left period. Definition of “small recovery sequence” and “medium recovery sequence” will be given later.

In the tenth embodiment, a period where the printer is left in non-use state (left period) is calculated. When the left period is longer than or equal to the predetermined period, after performing first pit-in ink supply (pit-in ink supply for improving ink draining performance) to the sub-tank, ink draining process for draining all amount (substantially all amount) of flowable ink in the sub-tank is performed. On the other hand, when the left period is shorter than the predetermined period, the first pit-in ink supply and the ink draining process are not performed. More particularly, when the left period is long, in advance of the second pit in ink supply (pit-in ink supply for printing operation), first pit in ink supply and ink draining process are performed. On the other hand, when the left period is short, the first pit-in ink supply and ink draining process are not performed before the second pit-in ink supply.

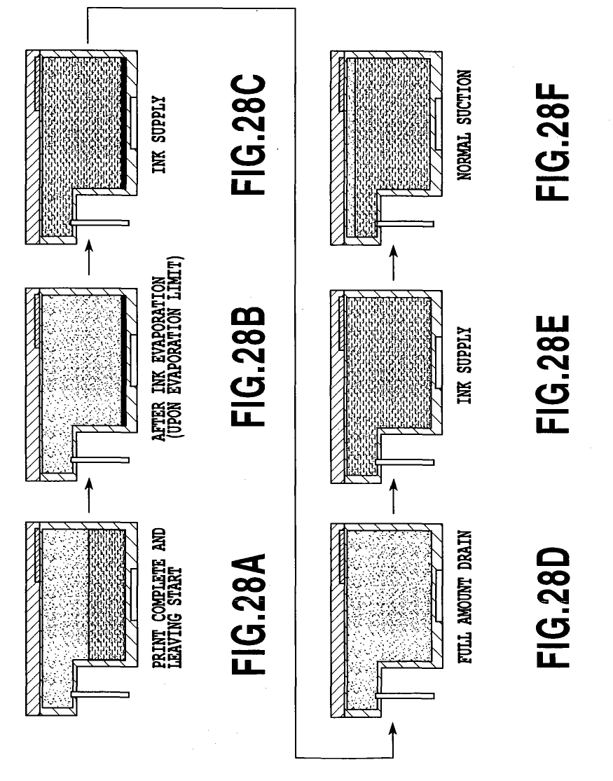

FIGS. 28A to 28F are diagrammatic representations showing states of the remaining ink in the sub-tank. FIG. 28A shows that the ink remaining amount in the sub-tank at completion of printing at the preceding time and before being left is minimum amount (here, 0.15 cc). Ink amount capable to be stored in the sub-tank is 0.4 cc, maximum size of the printing paper is 4″×6″ (4 inches×6 inches), and ink amount to be used for printing is 0.2 cc (each color) at the maximum. Ink amount to be used for recovery process (suction operation) to be performed as required upon printing is 0.04 cc. Assuming ink amount to be used for recovery process to be performed as required upon printing is 0.05 cc in consideration of fluctuation, ink amount derived by subtracting ink amount used for printing and ink amount used for recovery process from the ink amount 0.4 cc as capacity of the sub-tank (i.e. 0.15 cc) becomes the minimum ink remaining amount in the sub-tank immediately after printing.

The tenth embodiment used ink containing 5% by weight of coloring agent, 20% by weight of non-volatile solvent (8% by weight of glycerin, 6% by weight of diethylene glycol, 5% by weight of urea and about 1% of surface active agent), and remaining 75% by weight of volatile solvent (72.5% by weight of water, 2.5% by weight of isopropyl alcohol). Since volatile component is 75% by weight, evaporative amount becomes 150 μl×0.75=112.5 μl. Assuming that evaporation speed is 2 μl/day similarly to the fifth embodiment, volatile component is evaporated substantially completely within 56 days. In practice, evaporation becomes moderate before the inflection point to saturate with smooth curve. At the evaporation limit, viscosity of ink is quite high as high as about 400 mpas. The state at the evaporation limit is shown in FIG. 28B.

Therefore, in this embodiment, before performing ink draining process for draining ink with high viscosity in advance of pit-in ink supply (second pit-in ink supply) for printing operation, pit-in ink supply (first pit-in ink supply) is performed for improving ink draining performance by supplying fresh ink to the sub-tank. In the sub-tank, ink with high viscosity and fresh ink are mixed to drain all amount of flowable ink in the sub-tank.

As shown in FIG. 28C, upon performing printing after being left, if the left period is longer than or equal to predetermined period (here, longer than or equal to 60 days), ink is supplied by pit-in ink supply so as to fill-up the sub-tank. Next, in the state shown in FIG. 28D, full amount suction of ink is performed. Discussion will be given for full amount suction in sub-tank with reference to general structure of the pit-in ink supply and recovery system of FIG. 4. After fitting the cap B310 on the printing head B120, the atmosphere communication valve (not shown) connected to the atmosphere communication opening B404 is closed to form enclosed space in the cap B310. Then, piston is moved in the direction of arrow in the cylinder pump B304. Since ink with quite high viscosity (also referred to as ink of high viscosity or remaining condensed ink) in the head is present, response of ink after application of pressure is low. In some cases, flow of ink is not caused even when the piston is moved in full stroke. At this time, negative pressure is quite large as large as about 80 kPa. By continuing this condition for about several tens seconds, even ink of high viscosity may be drained as long as ink does not firmly adhere.

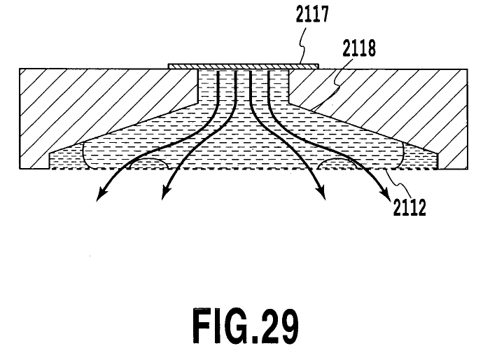

As set forth above, it is possible that ink of high viscosity partially remains without being drained. However, in the shown embodiment, since pit-in ink supply to the sub-tank is performed before performing ink draining process for driving the ink of high viscosity (remaining condensed ink) in the sub-tank, fresh ink supplied into the sub-tank by pit-in ink supply flows to the portion where the ink of high viscosity remains as shown by arrow in FIG. 29. By this arrangement, ink of high viscosity is solved to a state to be easily drained. On the other hand, ink amount to be drained flowing through the ink passage 2118 is larger than that in normal recovery process and therefore, ink of high viscosity can be more effectively solved and drained. As set forth above, in the shown embodiment, by washing remaining condensed ink with fresh ink before ink draining process for solving, remaining condensed ink can be easily drained during the ink draining process. As a result, when second pit-in ink supply is performed for filling up ink to the sub-tank again as shown in FIG. 28E and then normal recovery process (suction operation) is performed as shown in FIG. 28F, ejection failure is not caused in the nozzles even after being left for a long period, good quality of printing can be thus obtained.

It should be noted that, as a comparative example, from the condition shown in FIG. 28C, normal recovery process of FIG. 28F (suction operation) was performed directly (skipping steps of FIGS. 28D and 28E) and subsequently printing was performed (this series of processes will be hereinafter referred to as “small sequence”). In such case, since viscosity of ink is high, ink of high viscosity remained to make recovery impossible. It should be noted that normal recovery process (suction operation) means suction recovery to be performed after filling ink in the sub-tank by pit-in ink supply system, and is suction recovery for sucking 0.4 cc of ink of each color as set forth above. Concerning the normal recovery, discussion will be given with reference to the general structure of FIG. 4. After fitting the cap B310 on the printing head B120, the atmosphere communication valve (not shown) is closed to block atmosphere communication opening B304 to form the enclosed space within the cap b310. Then, ink is sucked from the nozzle with shifting the piston in the cylinder pump B304 in the direction of arrow and suction is terminated by opening the atmosphere communication value after about 1.5 sec. It is understood that in such suction, negative pressure for suction is small and suction period is short to be insufficient for draining ink of high viscosity.

It should be noted that, as set forth above, “small recovery sequence” is a sequence from the state shown in FIG. 28B to the state shown in FIG. 28F via the condition shown in FIG. 28C (skipping conditions of FIGS. 28D and 28E. In short, the small recovery sequence is a recovery sequence to perform pit-in ink supply (second pit-in ink supply as shown in FIG. 28C for next printing) for the sub-tank containing ink of high viscosity (remaining condensed ink) after being left (state shown in FIG. 28B, and subsequently performing normal recovery process (FIG. 28F)). It should be noted that in “small recovery sequence”, the state shown in FIG. 28C corresponds to the second pit-in ink supply.

Furthermore, definitions for other sequences will be given. As set forth in the ninth embodiment, a sequence from the state shown in FIG. 28B to the condition shown in FIG. 28F via conditions of FIGS. 28C, 28D and 28E is referred to as “large recovery sequence”. In short, “large recovery sequence” is a recovery sequence to perform pit-in ink supply for improving ink draining performance (first pit-in ink supply shown in FIG. 28C) to the sub-tank in the state where ink of high viscosity (remaining condensed ink) is present after being left (condition shown in FIG. 28B), then performs ink draining process (full amount draining) of FIG. 28D, thereafter perform pit-in ink supply for next printing (second pit-in ink supply shown in FIG. 28E), and subsequently perform normal recover process (FIG. 28F). It should be noted that in a “large recovery sequence”, FIG. 28C corresponds to the first pit-in ink supply and FIG. 28E corresponds to the second pit-in ink supply.

Also, definitions for still other sequences will be given: a sequence-from the state shown in FIG. 28B to FIG. 28F via FIGS. 28D and 28E (skipping step of FIG. 28C) is referred to as “medium sequence”. In short, “medium sequence” is the recovery sequence to perform ink draining process (full amount draining) of FIG. 28D for the sub-tank of the state where ink of high viscosity (remaining condensed ink) after being left is present (state shown in FIG. 28B), then perform pit-in ink supply (second pit-in ink supply shown in FIG. 28E) for next printing, and subsequently perform normal recovery process (FIG. 28F). In the “medium recovery sequence”, FIG. 28E corresponds to the second pit-in ink supply.

Concerning measurement of left period in the shown embodiment, even in the state where the power source of the main body is turned OFF, ASIC500 is periodically actuated using the internal battery 515 to count UP the period of time to maintain the power source of the printer OFF (namely left period) to store in EEPROM 509. Then, upon next printing, when the value of the left period (count value) is longer than or equal to the predetermined period (here longer than or equal to 60 days), draining of all amount of flowable ink in the sub-tank is performed after supplying fresh ink in the sub-tank by pit-in ink supply, then refilling ink to the sub-tank by pit-in ink supply again, and subsequently perform normal recovery operation (suction operation and so on) to perform printing.

On the other hand, during suction, the sub-tank is communicated with the atmosphere through an air suction opening via the vapor-liquid separation membrane and the air chamber and is also communicated with the atmosphere by placing the needle opened without piercing into a joint rubber. By performing suction under atmosphere communicating state, air is sucked through the air suction opening or the needle, and then ink in the sub-tank is sucked into the cylinder pump through the nozzles. As set forth above, evaporation speed is that in most severe condition of evaporation among operational environments of the printer. Here, evaporation speed preliminarily derived through experiments under environmental condition of 30° C. of atmospheric temperature and 10% of relative humidity, is taken as evaporation speed.

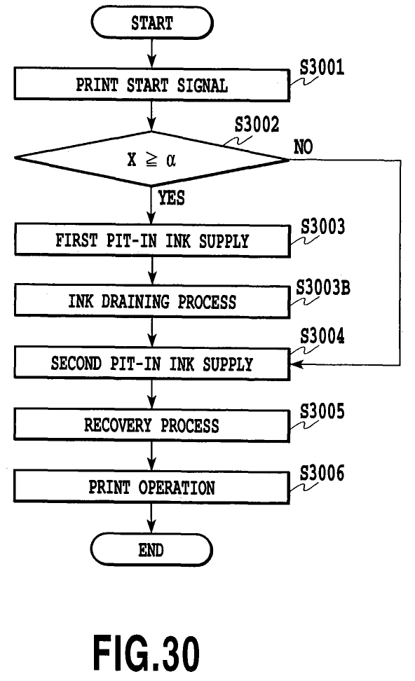

Here, ink draining process sequence of the tenth embodiment will be discussed with reference to FIG. 30. Briefly, in the tenth embodiment, control whether small recovery sequence is to be performed or large recovery sequence is to be performed is performed depending upon left period. In FIG. 30, discussion will be given for the process taking a period of time of next printing (upon reception of the next print start signal) as time of judgment on whether pit-in ink supply for improving ink draining performance and the ink draining process are to be performed or not.

Discussion will be given for flowchart of FIG. 30. At first, when the print start signal is received at step S3001, judgment is made on whether the time count value X is greater than or equal to the threshold value a at step S3002. When the value X is less than α at step S3002, process is advanced to step S3004 without performing the first pit-in ink supply (step S3003A) and ink draining process (step S3003B). On the other hand, if the value X is greater than or equal to α, the ink draining process is performed at step S3003B after performing the first pit-in ink supply at step S3003A (pit-in ink supply for improving ink draining performance). Subsequently, process is advanced to step S3004. The draining amount in the ink draining process can be the same as that in the ninth embodiment. After performing pit-in ink supply (second pit-in ink supply) for printing operation at step S3004, normal recovery operation (suction operation) is performed at step S3005. Then, printing operation is performed at step S3006. It should be noted that the flowchart shown in FIG. 30 may be modified to execute the process each time of reception of the print signal or to execute only upon reception of the first print start signal after turning ON of power source.

With the foregoing tenth embodiment, control whether the first pit-in ink supply and the ink draining process are to be performed before the second pit-in ink supply or not is performed depending upon the left period (for example, left days). Therefore, it becomes possible to restrict problem of condensation of ink (particularly, occurrence of ejection failure in the nozzles) while restricting ink draining amount, and good quality of image can be printed.

(Eleventh Embodiment)

In the eleventh embodiment, whether the first pit-in ink supply and ink draining process are to be executed or not is determined considering not only the left period but also the amount of remaining ink (ink remaining amount) in the sub-tank at the completion of printing at the preceding time. In short, control whether large recovery sequence is to be performed or small recovery sequence is to be performed, is performed on the basis of the ink remaining amount in the sub-tank at the completion of the printing at the preceding time and the left period.

A greater ink remaining amount in the sub-tank results in a longer period of time to reach the evaporation limit. When ink remaining amount in the sub-tank is 400 μl, the time period to reach the evaporation limit is 150 days, when ink remaining amount in the sub-tank is 300 μl, the time period to reach the evaporation limit is 112 days, when ink remaining amount in the sub-tank is 200 μl, the time period to reach the evaporation limit is 75 days and when ink remaining amount in the sub-tank is 150 μl (minimum remaining amount) as in the tenth embodiment, the time period to reach the evaporation limit is about 56 days. In other words, the period to reach the evaporation limit is significantly differentiated depending upon ink remaining amount in the sub-tank. The reason why influence of evaporation is significantly differentiated depending upon the initial ink remaining amount is originally caused due to small capacity of the sub-tank and thus is a problem specific to the pit-in ink supply system having small sized sub-tank. Therefore, in the tenth embodiment, in consideration of the minimum ink remaining amount, all amount of ink in the sub-tank is drained after ink supply to the sub-tank for draining the ink of high viscosity when the left days is longer than or equal to 60 days to solve locally remaining ink of high viscosity by washing so as not to cause ejection failure of the nozzle at next printing.

However, since the time period to reach the evaporation limit significantly differs depending upon ink remaining amount in the sub-tank at the completion of printing at the preceding time, when recovery sequence is determined without considering ink remaining amount in the sub-tank at the completion of the printing at the preceding time, it is possible that ink consuming amount becomes unnecessarily large. In other words, since the time period to reach the ink viscosity to cause necessity to perform ink draining process is differentiated, it is necessary to consider ink remaining amount in the sub-tank at the completion of printing at the preceding time in order to minimize ink consuming amount associating with the ink draining process.

Since the present invention is premised to relatively compact photograph printer, capacity of ink is not satisfactorily large. Therefore, when ink consuming amount is large, running cost per print for one sheet becomes high. Therefore, in the eleventh embodiment, in order to adapt to difference of the ink viscosity after being left depending upon ink remaining amount in the sub-tank at the completion of printing at the preceding time, recovery sequence is controlled in consideration of the left period and the ink remaining amount in the sub-tank at the completion of printing at the preceding time. In other words, in the eleventh embodiment, ink remaining amount in the sub-tank at the completion of printing at the preceding time is stored in EEPROM of the main body, and the left period is counted up and stored in the EEPROM as discussed in the tenth embodiment. Then, on the basis of the ink remaining amount in the sub-tank upon completion of printing at the preceding time and the left period, recovery sequence before printing for next printing is varied.

Particularly, on the basis of the ink remaining amount (v) at the completion of printing at the preceding time and left days (T), the recovery sequence is varied as shown by the following table 4. In the table, sign “-” represents that the first pit-in ink supply (pit-in ink supply for improving ink draining performance) and ink draining process are not performed before the second pit-in ink supply (pit-in ink supply for next printing), and second pit-in ink supply is performed and subsequently normal recovery process (suction recovery operation and preparatory ejection operation) are performed. In other words, the sequence corresponds to “small recovery sequence”. On the other hand, sign “o” represents that all amount of flowable ink in the sub-tank is drained after first pit-in ink supply, then second pit-in ink supply is performed and subsequently, normal recovery process is performed. In other words, the sequence corresponds to “large recovery sequence”.

TABLE 4

| | Left days | | | | | |
|---|---|---|---|---|---|---|
| | | 60 =< T | 75 =< T | 95 =< T | 115 =< T | |
| | T < 60 | <75 | <95 | <115 | T < 135 | 135 =< T |
| Ink | | | | | | |
| remaining | | | | | | |
| Amount (V) | | | | | | |
| 150 =< V < 100 | — | o | o | o | o | o |
| μl | | | | | | |
| 200 =< V < 250 | | | o | o | o | o |
| μl | | | | | | |
| 250 =< V < 300 | — | — | — | o | o | o |
| μl | | | | | | |
| 300 =< V < 350 | — | — | — | — | o | o |
| μl | | | | | | |
| 350 =< V < 400 | — | — | — | — | — | o |
| μl | | | | | | |

It should be noted that detection of ink remaining amount in the sub-tank at the completion of printing can be done as discussed in connection with the sixth embodiment.

As set forth above, with the eleventh embodiment, control whether the first pit-in ink supply and the ink draining process are to be performed or not is carried out depending upon the left period (for example, left days) and the ink remaining amount in the sub-tank at the completion of printing at the preceding time. Therefore, in addition to the effect of the tenth embodiment, ink consuming amount can be effectively reduced.

(Twelfth Embodiment)

The twelfth embodiment is characterized in that ink condensation degree is considered in addition to the left days at making judgment on whether or not the first pit-in ink supply and the ink draining process are to be performed before the second pit-in ink supply, or not. It should be noted that the reason for considering the ink condensation degree is set forth in connection with the seventh embodiment. On the other hand, method of calculation of the ink condensation degree is as discussed in connection with the seventh embodiment. In short, with the twelfth embodiment, control whether large recovery sequence is to be performed or small recovery sequence is to be performed is performed on the basis of the left period and the ink condensation degree.

(Thirteenth Embodiment)

The thirteenth embodiment is characterized by warming of the printing head before the ink draining process (for example, full amount draining process) of the ninth to twelfth embodiments. Since other construction is the same as the ninth to twelfth embodiment, discussion for such common components will be eliminated for avoiding redundant disclosure for simplification in order to facilitate clear understanding of the present invention. Warming process of the printing head is required to be performed before ink draining process, and therefore warming process can be performed after the first pit-in ink supply and before ink draining process, or before the first pit-in ink supply.

Method of warming process of the printing head is as discussed in connection with the eighth embodiment and can be done by application of the warming pulse. With this arrangement, full amount drainage of the ink in the sub-tank can be facilitated to improve reliability even when ink having quite high ink viscosity at the evaporation limit (such as ink containing large amount of glycerin) is used.

For example, when ink containing 5% by weight of coloring agent, 20% by weight of non-volatile solvent (14% by weight of glycerin, 2% by weight of diethylene glycol, 3% by weight of Urea and about 1% of surface active agent), and remaining 75% by weight of volatile solvent (72.5% by weight of water, 2.5% by weight of isopropyl alcohol) is used as ink, viscosity after evaporation of water component is high as ratio of glycerin is large to increase viscosity up to the state of substantially nearly 100% of glycerin. Results of recovering performance with using such ink and varying warming temperature are shown in the following table 5.

TABLE 5

| | | | Elevated |
|---|---|---|---|
| Warming | | | Temperature |
| Temperature | Ink Viscosity | Recovery | Reaching |
| (° C.) | (mPas) | Performance | Period (sec) |
| 25° C. (not | About 1000 | x | (Nil) |
| warmed) | | | |
| 30° C. | 560 | Δ | 2 seconds |
| 40° C. | 220 | o | 8 seconds |
| 50° C. | 90 | o | 15 seconds |
| 60° C. | 45 | o | 25 seconds |
| 80° C. | 18 | o | 45 seconds |

As can be clear from table 5, by warming ink of high viscosity after evaporation by the warming process, viscosity of ink can be lowered to improve ink improve recovery performance. However, when attempt is made to elevate the temperature about 80° C. for example, a time period required to reach the warmed temperature becomes long, to make waiting time period up to printing long. Therefore, preferred warming temperature is about 50° C.

(Fourteenth Embodiment)

The fourteenth embodiment is characterized in that ink amount to be supplied to the sub-tank by pit-in ink supply before ink draining process (full amount drainage process) is taken as amount necessary for recovery, instead of filling up the sub-tank. Since other structure is similar to the one in the ninth to thirteenth embodiment, discussion for such common components will be eliminated for avoiding redundant disclosure for simplification in order to facilitate clear understanding of the present invention. In particular, as a result of experiments, by washing nozzle by full amount draining after pit-in ink supply of ink in amount of 0.15 cc, subsequent recovery problem can be done without causing any problem. Therefore, it is set to supply 0.2 cc of ink for the purpose of providing margin.

Here, pit-in ink supply operation for supplying a predetermined amount of ink smaller than a filling up amount, instead of filling up the sub-tank, will be discussed with reference to FIG. 4. At first, inserting the needle B122 into rubber joint C105 to connect the negative pressure joint B302 and the air suction opening B123. Subsequently, piston in the cylinder pump B304 is moved in the direction of arrow. At the stroke of the piston corresponding to 0.2 cc×three colors=0.6 cc, the cylinder pump is situated in a waiting state. By such operation, the predetermined supply amount, i.e. 0.2 cc, cannot be supplied unless the time period for pit-in ink supply is expanded in relation to development of negative pressure in the sub-tank, thus making waiting period to print longer. However, this significantly contributes for reduction of ink consuming amount.

(Fifteenth Embodiment)

The fifteenth embodiment is characterized in that it provides waiting period from completion of the first pit-in ink supply to starting of ink draining process and whereby promoting solving of ink of high viscosity remained in the sub-tank. Specifically, at performing a large recovery sequence, providing the waiting period at a point of time when the first pit-in ink supply is completed (condition of FIG. 28C), a greater amount of ink of high viscosity in the sub-tank is solved by fresh ink, thus improving recovery performance in the subsequent normal recovery process. On the other hand, it is also possible to provide the waiting period in the state shown in FIG. 28E. Particularly, since ink of high viscosity in the nozzle array portion is difficult to solve, providing the waiting period under presence of fresh ink is effective for recovery. Furthermore, by providing waiting period in both states of FIGS. 28C and 28E, reliability can be improved by further promoting solving of the ink of high viscosity. Of course, it is possible to combine providing of the waiting period and warming process discussed in connection with the thirteenth embodiment.

(Sixteenth Embodiment)

The sixteenth embodiment is characterized in that it provides a temperature-humidity sensor in the main body of the apparatus, stores history or log data of temperature and humidity by ASIC simultaneously with counting up of the left period, correcting evaporation speed (or evaporation ratio α, evaporation amount) which is parameter corresponding to the ink viscosity on the basis of environmental history, and whereby optimally reducing the ink draining amount associating with ink draining process corresponding to ink viscosity. Since other structure is similar to the one in the fifth to fifteenth embodiments, discussion for such common components will be eliminated for avoiding redundant disclosure for simplification in order to facilitate clear understanding of the present invention.

In the fifth to fifteenth embodiments, evaporation speed under a condition where evaporation is most significant (temperature being high and humidity being low) among use range of the printer, is taken as the evaporation speed. However, in actual environment, evaporation is not so significant in many cases. Accordingly, in consideration of the evaporation speed (or evaporation ratio α, evaporation amount) under a condition where evaporation is most significant, if ink draining amount associating with ink draining process is determined, more than necessary ink may be consumed.

Therefore, in the sixteenth embodiment, evaporation speed (or evaporation ratio α, evaporation amount) is corrected depending upon environmental history or log data (history or log data of environment including temperature and humidity) in the left period of the main body of apparatus to see the state of ink in the sub-tank more accurately. It should be noted that process of temperature-humidity data may be average of the values over the left period or may provide weight depending upon period of time, such as start of being left, termination of being left or so forth. By correcting evaporation speed (or evaporation ratio α, evaporation amount) on the basis of history of left environment of the main body of the apparatus, ink consuming amount can be further reduced.

(Seventeenth Embodiment)

The shown embodiment is characterized by selecting recovery sequence to perform among a plurality of recovery sequences including the above-explained small recovery sequence, medium recovery sequence and large recovery sequence depending upon the left period. With this arrangement, in comparison with the fifth embodiment or tenth embodiment, ink consuming amount required for recovery sequence can be made closer to the minimum necessary amount.

(Eighteenth Embodiment)

The shown embodiment is characterized by selecting recovery sequence to perform among a plurality of recovery sequences including the above-explained small recovery sequence, medium recovery sequence and large recovery sequence, depending upon the left period and ink remaining amount at the completion of printing at the preceding time. With this arrangement, in comparison with the sixth embodiment or eleventh embodiment, ink consuming amount required for recovery sequence can be made closer to the minimum necessary amount.

(Nineteenth Embodiment)

The shown embodiment is characterized in that it selects recovery sequence to perform among a plurality of recovery sequences including the above-explained small recovery sequence, medium recovery sequence and large recovery sequence, depending upon the left period and ink condensation degree. With this arrangement, in comparison with the seventh embodiment or twelfth embodiment, ink consuming amount required for recovery sequence can be made closer to the minimum necessary amount.

(Twentieth Embodiment)

In the foregoing first embodiment, the ink draining process is performed at a point of time before starting printing, whereas, in the twentieth embodiment, the ink draining process is performed at a point of time after completion of printing. It should be noted that “point of time after completion of printing” means a point of time taking turning OFF of the power source as trigger, point of time taking reception of the print end signal indicating end of printing as trigger, and point of time similar to them.

In the twentieth embodiment, since the remaining ink in the sub-tank is drained after completion of printing, the sub-tank can be left in the state where little amount of remaining ink is contained. Accordingly, even when printing is performed after being left for a long period of time, problems associated with condensation of ink is not caused. It should be noted that when printing is performed after the sub-tank is left (i.e., when next printing operation is performed), in normal way, as soon as the print start signal is received, pit-in ink supply (second pit-in ink supply) for printing operation is performed, and subsequently, printing is started after performing normal recovery process.

(Twenty-First Embodiment)

In the twenty-first to twenty-fourth embodiments, ink draining to make remaining ink amount in each color substantially equal to each other is performed in the ink draining process (first ink draining process) upon completion of printing operation in order to make reproductivity of color high by reducing fluctuation of ink condensation ratios in respective colors of the sub-tanks after supplying ink in the sub-tanks, as a common feature. Hereinafter, the reason to perform ink draining so that remaining ink amounts in respective colors become substantially equal to each other will be discussed.

Significant difference caused between remaining ink amounts in respective colors of sub-tanks in some types of images, is undesirable for the reason set forth below. It should be appreciated that differentiating remaining ink amounts in respective colors depending upon some types of images means that when the image to be printed is sky in fine weather, a large amount of cyan ink is consumed to make remaining amount of cyan ink small and relatively large amount of magenta and yellow inks remain.

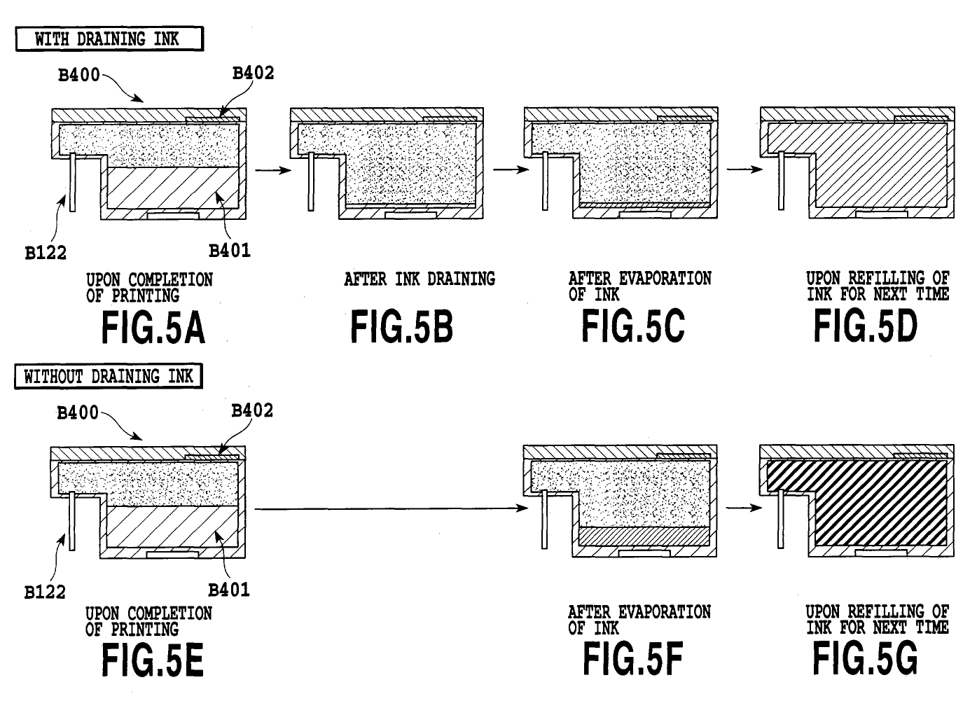

FIGS. 5A to 5G are schematic representations for explaining condition of remaining inks in a plurality of sub-tanks, where cases when draining of ink is performed before pit-in ink supply and when draining of ink is not performed, are illustrated. FIG. 5A shows ink remaining amount at the completion of printing, wherein approximately medium amount of ink remains in the sponge, FIG. 5B illustrates a state where ink is drained by ink draining, FIG. 5C illustrates a state after evaporation of volatile component of ink in the sub-tank, and FIG. 5D shows a state where ink is filled for next printing (state after pit-in ink supply).

While illustrated diagrammatically, in the state shown in FIG. 5B, ink cannot be drained completely—especially, ink coloring sponge (here ink wetting sponge fiber) is difficult to drain—even when ink is drained at the completion of printing at the preceding time. Therefore, even when ink is filled for next printing as shown in FIG. 5D, it is inherent that density of ink becomes higher than initial ink density.

On the other hand, states in the case where ink draining is not performed are shown in FIGS. 5F and 5G, wherein FIG. 5F shows the state where sub-tank is left for drying without performing ink draining and shows that the amount of remaining condensed ink is greater than that of FIG. 5C, and FIG. 5G shows a state where ink is filled for next printing (state after pit-in ink supply) and the density of ink is higher than the initial ink density.

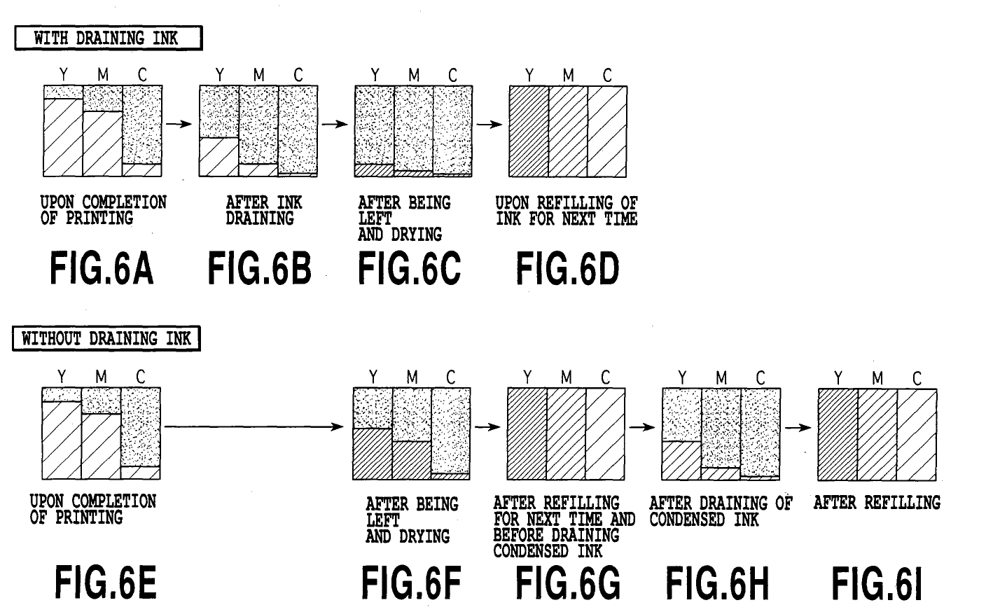

In either case, it is inherent that density of the ink becomes higher than the initial ink density. While the foregoing discussion has been given for the phenomenon caused in the sub-tank of one color, in case of a full color printing apparatus, at least three or more colors of inks are used and corresponding number of sub-tanks are present. The states in case of sub-tanks for full color printing are diagrammatically illustrated in FIGS. 6A to 6I.

FIGS. 6A to 6I are diagrammatic representations showing ink amount in sub-tanks of three colors of Y, M and C, wherein FIG. 6A shows the state at the completion of printing (for example, by printing image of sky in fine weather as set forth above), wherein remaining amounts of Y and M inks are large and remaining amount of C is extremely small.

In FIGS. 6A, 6B, 6C and 6D show states in the case where ink draining is performed, wherein, even if remaining ink is attempted to drain after printing state of FIG. 6A, it is not possible to establish ink drained state of equal level in three colors, as shown in FIG. 6B. This is the case where ink draining is performed by suction and is caused in the case where suction of three colors of Y, M and C color inks by a single cap. In other words, in the case of a simultaneous suction for three colors, when ink of one color is drained out, inks of other colors are difficult to be drained. The reason is that after drained out of e.g. cyan ink, air flow passage is formed to make negative pressure for drawing ink smaller (it should be noted that, as illustrated, even the cyan ink, it is not possible to drain ink completely. Breakage of meniscus or membrane of ink in ejection holes of cyan printing head may form air passage in several nozzles. As a result, even cyan ink, it is quite difficult to completely drain ink in all nozzles).

Then, as illustrated, when the sub-tanks are left for drying in the condition where draining of yellow ink is insufficient, ink remaining state becomes as illustrated in FIG. 6B. When refilling of ink is performed at this condition, condensation ratios of inks can be differentiated between respective colors as shown in FIG. 6D. When balance of condensation ratios is lost, it results in not only causing density of primary colors such as yellow (also magenta in the shown case) higher but also causing variation of color hues in secondary colors. In other words, in the shown example, while cyan has ink density substantially equal to the initial ink density, condensation ratio of yellow ink becomes higher, and as a result, upon reproducing green color, color of green can have yellowish color taste or hue to cause local variation of color taste in the printed image to make unnatural feeling in the entire image significant.

In this case, problem becomes more significant than the case where printing is performed with inks of other colors condensed in comparable degree as the yellow ink of the foregoing example. The reason is that when densities of all colors are high, while density of the entire image becomes high, color hue in respective portions of the image is substantially the same as the image printed with the inks of initial densities. When balance of densities of inks of respective colors is lost as in the shown example, color hue can be differentiated particularly in the portion of the image of secondary colors. Therefore, image is not of simply increased density, and in the shown case, the image, particularly in portion of the green color in the image, becomes yellowish, although a portion of the image of blue color can be output substantially acceptable color. Thus, local variation of color hue in the image is caused, and unnatural taste or feeling of the overall image becomes significant.

On the other hand, even in the case where draining of inks is not performed as illustrated in lower row of FIGS. 6E to 6I, the substantially the same result is caused as the case of draining the ink. Specifically, when the remaining amounts of inks are left to dry as shown in FIG. 6F after completion of printing as shown in FIG. 6E, and subsequently inks are refilled for next printing, densities of the condensed inks are significantly differentiated among three colors as shown in FIG. 6G. In the state of FIG. 6G, if suction is performed with capping three colors of nozzles in a lump, viscosities of the inks are differentiated associating with difference of densities of inks to results in different flow resistances in respective colors of inks. Therefore, it becomes impossible to drain the condensed inks uniformly as shown by FIG. 6H. Therefore, even when fresh inks are refilled as shown by FIG. 6I, densities of the inks after refilling can be different to destroy balance.

Such a problem can be solved by performing capping and suction for each color of nozzles individually instead of capping and suction for nozzles of three colors in a lump. However, such solution encounters a drawback in that the printing apparatus becomes bulky and complicate. In the alternative, even in suction for the nozzles of three colors in a lump, fluctuation of the ink remaining amounts after suction as shown by FIG. 6B or FIG. 6I can be reduced if suction is performed for a long period. However, it is not always possible to establish balance of remaining amounts of inks in three colors even when suction is performed for a long period. Furthermore, performing suction for a long period inherently makes process time long. Such a problem in balance of condensation ratio has neither been recognized nor suggested in the prior art, and thus is new problem.

The twenty-first to twenty-fourth embodiments have been worked out in view of the problems set forth above. It is therefore an object of the following embodiments to reduce fluctuation of ink condensation ratio of respective sub-tanks after refilling of ink in the sub-tanks, resulting in natural color densities of image with superior reproductivity, and preventing visually perceptive difference of densities between images even when the same image is printed repeatedly and sequentially.

It should be noted that, in these embodiments, in order to reduce size of the printer portion, size of output product of the printer is selected to be a card size instead of so-called L-size frequently seen in analog silver halide photograph. The card size is a size of about 54 mm×86 mm equivalent to the size of name card. For example, upon printing at 1200×1200 dpi, in view of pixel size, necessary size of droplet of ink may be about 4 to 5 pl. Therefore, necessary ink amount for forming image becomes about 0.055 cc. Assuming recovery amount after refilling ink is 0.02 cc, for example, necessary ink amount becomes 0.075 cc. Capacity of sub-tank is set at 0.1 cc.

In the shown apparatus, in order to detect ink amount residing in the sub-tank after printing at a high accuracy, an ink amount to be stored in the sub-tank and an ink amount to be drained by suction recovery operation are stored as fixed values in ROM 504 or EEPROM 509. There is a little fluctuation in ink amount to be filled in the sub-tank by each ink refilling operation and in ink amount drained in each suction recovery operation per main body of the printing apparatus. Therefore, it is preferred to correct such fluctuation to improve accuracy in detection of ink residual amount.

EEPROM 509 has a memory region (hereinafter referred t as dot counter) for integrating ink amount ejected by ejecting operation in a unit of 1 pl. By subtracting ink amount drained by recovery operation and ink amount counted by the dot counter from the ink amount to be stored in the sub-tank, amount of residual ink in the sub-tank can be calculated. Here, since the capacity of the sub-tank is set at 0.1 cc, precision in detection of ink residual amount is preferably smaller than or equal to 0.0001 cc. It should be noted that there is a little fluctuation in ink amount of the ink droplet per one shot per printing head, and that precision can be improved by correcting such fluctuation.

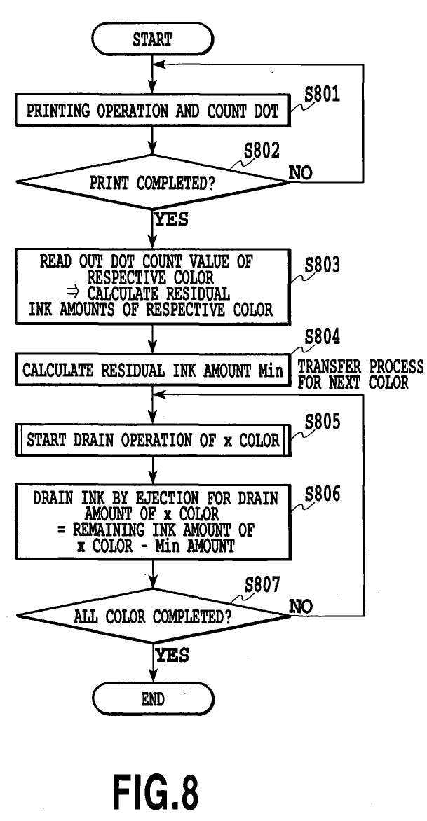

FIG. 8 shows a sequence of ink drainage in the twenty-first embodiment. After starting, at first, at S801, simultaneously with printing operation, used amount of ink is integrated up to completion of printing operation by the dot counter as counting means. After completion of printing at S802, dot counter values Dc, Dm and Dy for respective colors of cyan, magenta and yellow are read out (S803), and residual ink amounts of respective colors are calculated based on the dot counter values. For example, when the capacity of sub-tank is 0.1 cc, ink amount to be filled in the sub-tank at full state is 0.085 cc subtracting volume of sponge and volume of dead air. Next, after refilling ink at every time, ink amount to be drained upon suction recovery is 0.02 cc. These values are stored in ROM 504 or EEPROM 509. In adjustment in factory, if there is fluctuation between the main bodies, such fluctuation should be corrected. Residual ink amount Rc in the sub-tank of cyan is derived from these values as Rc=0.085−0.02−Dc. In similar manner, residual amounts Rm and Ry of magenta and yellow are also derived.

Next, at S804, Min value among residual amount of respective colors is calculated by Min=Min (Rc, Rm, Ry). As first drainage process, draining of inks of respective colors is performed at S805 and subsequent steps using the Min value and residual amount values of respective colors. At first, concerning cyan, draining amount is derived at step S806. Here, the draining amount corresponds to a difference between the residual amount of cyan ink and Min value. Then, first draining process is performed by draining ink in amount corresponding derived drainage amount. Next, similar process is repeated (step S807) until process is performed for all colors including other colors. After drainage of inks of respective colors, process is terminated.

It should be appreciated that draining process of ink is performed by ejection, suction drainage may be performed as required. It is also possible to perform both of ejecting drainage and suction drainage.

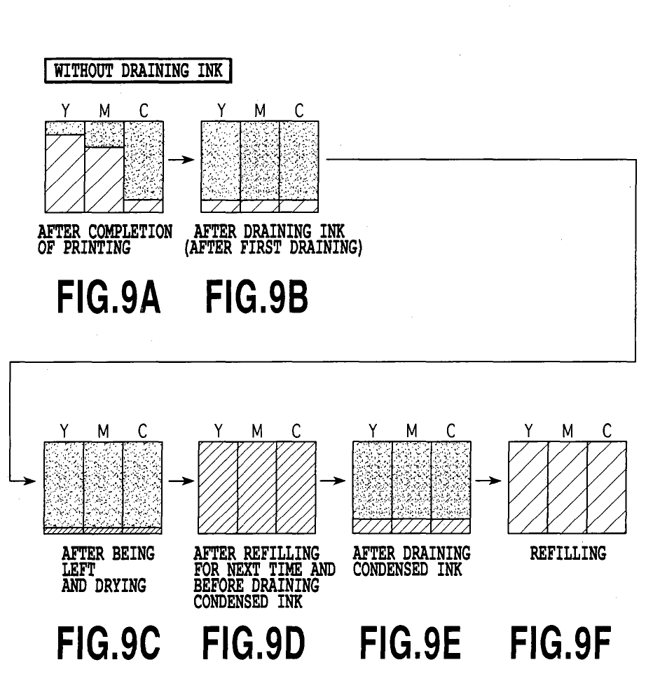

States of residual ink in the sub-tank at this time is illustrated in FIGS. 9A to 9F. By comparing FIGS. 9A to 9F with FIGS. 6A to 6I, effect of the shown embodiment will be understood. FIGS. 9A to 9F show application of the shown embodiment for the process in “not draining of ink” shown in FIGS. 6E to 6I, in which the process of FIG. 9B (first ink draining process) is added. By repeating the process of S806 shown in the sequence of FIG. 8, the state of FIG. 9B is established. By this first ink draining process, even if fluctuation is caused in ink remaining amounts of respective colors in the sub-tanks after completion of printing, inks of respective colors are consumed up to the equal level to substantially eliminating fluctuation of ink remaining amount of respective colors as shown by FIG. 9B, and thus, ink remaining amounts of respective colors can be balanced.

While the subsequent process is the same as set forth above (discussed with respect to FIGS. 6E to 6I), the states in the sub-tank is different from those of FIGS. 6E to 6I. After process of FIG. 9B, process is completed. Then, printer is left in non-use state. While the printer is left in non-use state, ink is dried to condense the residual ink as in FIG. 9C. Then, ink exchanging process is performed for condensation of ink in not shown sequence in next printing operation as shown FIGS. 9D and 9E, degrees of condensation in respective colors of inks are substantially the same, viscosity of the inks may not be varied significantly to permit exchanging of inks with maintaining balance in densities. Finally, in a state of FIG. 9F immediately before printing, condensation degrees of respective colors in condensed inks do not fluctuate significantly, and condensation degrees per se are small.

Upon performing durability test of the shown printer using such sequence, not only ink densities after refilling of ink but also ink condensation ratios in respective colors did not have significant difference between colors. As a result, color hue of the image can be natural to achieve high reproductivity of color hue. Furthermore, even when the same image is printed continuously, it becomes possible to provide printed outputs having color hue not fluctuating in visually perceptible extent.

It should be noted that since degree of evaporation of the ink is variable depending upon elapsed time, it is possible to perform ink draining process after refilling of ink shown in FIG. 9E, only when the printing apparatus is left non-use for several consecutive days, or as required. In the alternative, in case of the printer causing little evaporation or not being required severe color reproductivity of the image, such sequence may not be provided. In the mode not performing ink draining process after refilling of ink as FIG. 9E, printing operation may be started after refilling ink at FIG. 9D. It should be noted that, in case of this mode of implementation, ink density in the sub-tank becomes higher than initial ink density to result in higher density of the printed image, but no problem in color hue is caused since balance of density of respective colors is not lost. Therefore, reproductivity of color hue is sufficiently acceptable.

(Twenty-Second Embodiment)

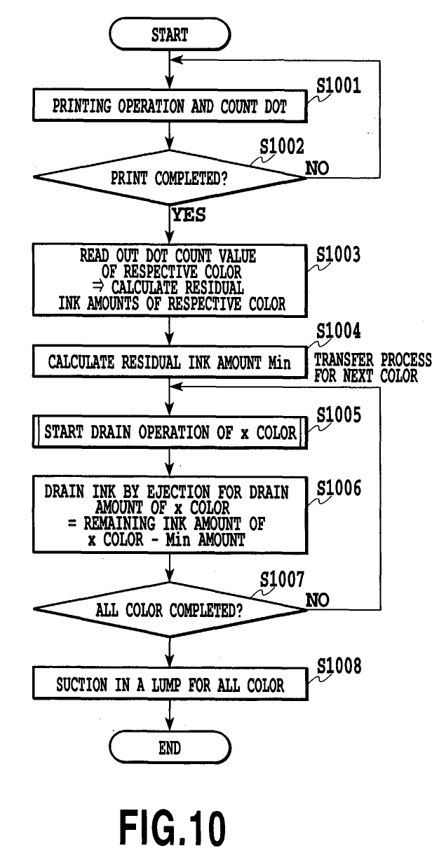

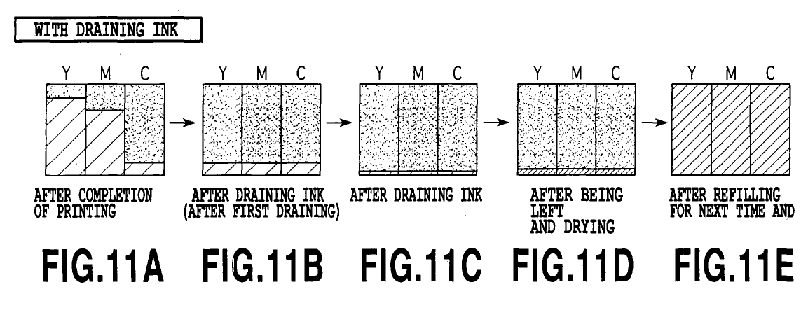

The twenty second embodiment is characterized in that a sequence of ink drainage is as shown by the flowchart of FIG. 10. By performing ink drainage using the shown sequence, residing state of ink in the sub-tank as shown in FIGS. 11A to 11E is realized. FIGS. 11A to 11E show residing state of ink in the sub-tank when the shown embodiment is applied to the process of “ink drained” in FIGS. 6A to 6D.

FIG. 10 adds suction process in a lump for all colors at S1008 for the process shown in FIGS. 9A to 9F. The sequence of the shown embodiment in FIG. 10 is differentiated from FIGS. 9A to 9F in this step S1008 and is the same for the rest. In the process of FIG. 10, after completing ink draining process of each color (first ink draining) for all colors at S1007 (FIG. 11C), “suction in a lump” as second ink draining process is performed at S1008 (FIG. 6B) for draining out residual ink in the sub-tank as much as possible. Here, “suction in a lump” means the process for sucking inks in respective sub-tanks simultaneously and in amounts equal to each other.

It should be noted that the second ink draining process may be performed following to the first ink draining process, or, in the alternative, may be performed at a point of time after completion of the first ink draining process but before next printing operation.

Even in the twenty-second embodiment, similarly to the twenty-first embodiment, after refilling of ink for next printing operation, ink condensation ratios may have little difference between respective colors, and the color hue of image can be natural, and reproductivity of color hue is superior. Therefore, it has been confirmed that even when the same image is printed sequentially, printed outputs having color hue not fluctuating in visually perceptible extent can be obtained.

It should be appreciated that since the shown embodiment does not require exchanging of ink before next printing as required in the twenty-first embodiment, ink consuming amount can be reduced as compared with the twenty-first embodiment.

(Twenty-Third Embodiment)

While a sequence flowchart of this embodiment is not illustrated, timing of S805 and subsequent processes of FIG. 8 or timing of S1005 and subsequent processes of FIG. 10 are differentiated. In the foregoing embodiments, step S805 and subsequent processes are performed immediately after completion of printing. In contrast to this, in this embodiment, step S805 and subsequent processes are performed at a point of time of turning OFF of the printer. In the alternative, it is also possible to perform step S805 and subsequent processes at a point of time of automatic turning OFF on camera side. In either case, since draining process at step S805 and subsequent steps is performed upon detection of turning OFF of power source, it becomes possible to shorten a process period from completion of preceding printing to starting of current printing. Therefore, it becomes possible to perform next printing operation without keeping the user waiting for a long period.

(Twenty-Fourth Embodiment)

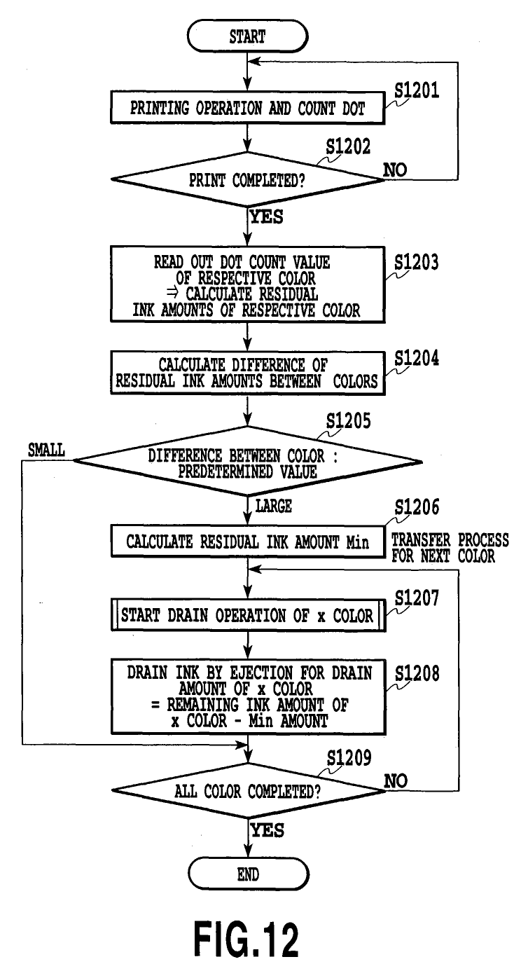

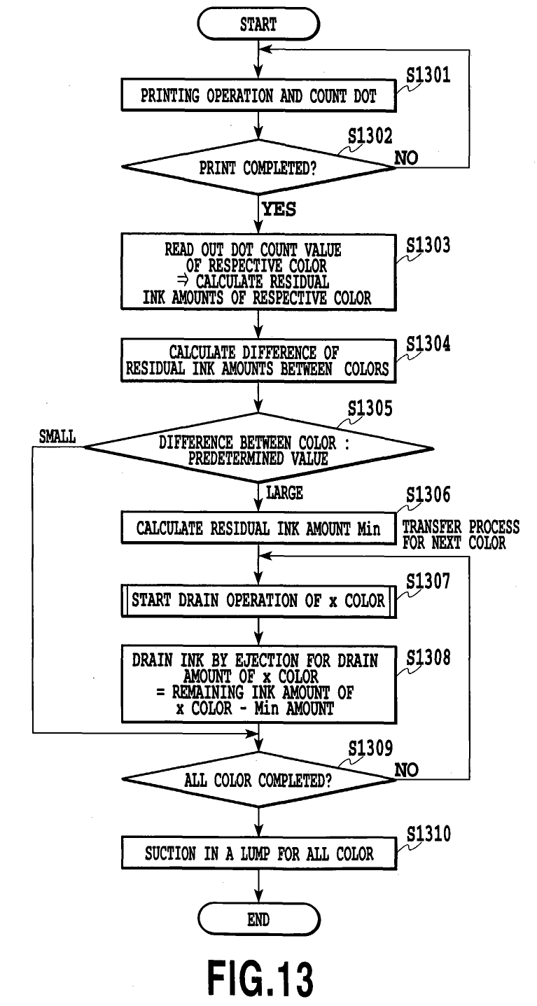

In this embodiment, judgment process for comparison with a predetermined amount is added between steps S803 and S804 of FIG. 8 or between steps S1003 and S1004 of FIG. 10, as shown in FIGS. 12 and 13.

In the shown embodiment, after calculation of the residual ink amounts of respective colors, a difference of the residual ink amounts between respective colors of sub-tanks is derived. If the difference is not excessively large (i.e. the difference of the residual ink amounts between the sub-tanks is smaller than or equal to the predetermined value), process is terminated without performing the first ink draining process. When the difference of the residual ink amounts of respective colors is small, condensation ratios of inks between colors are not differentiated significantly. Therefore, it is unnecessary to equalize the ink remaining amounts between respective colors. In this case, the first ink draining process to be performed for adjusting ink remaining amounts between respective colors to be substantially equal to each other is eliminated. The predetermined value as a threshold value for making judgment on large or small of the difference of ink remaining amounts between the colors, is set preliminarily, and is set at 0.01 cc in the shown embodiment. Here, since the capacity of sub-tank is 0.1 cc, if the difference is up to 0.01 cc of one tenth of the sub-tank capacity, no significant difference is caused in condensation ratios of respective colors. Therefore, ink draining process is not performed for strictly equalizing the ink remaining amount. The predetermined value used herein may be appropriately varied depending upon degree of evaporation and application of the printer. In the twenty-fourth embodiment, when the difference of ink remaining amounts of respective colors is small, ink draining process for equalizing the ink remaining amount (first ink ejection) is not performed, so that ink consuming amount can be made smaller than those of the twenty-first to twenty-third embodiments. Also, it becomes possible to shorten a process time from completion of preceding printing to starting of current printing.

(Other Embodiments)

In the foregoing twenty-first to twenty-fourth embodiments, ink draining process is performed after completion of printing operation so that amounts of remaining condensed inks are the same in respective colors. However, it is also possible to perform ink draining process at a point of time before starting printing.

On the other hand, as long as possible to combine, the first to twenty-fourth embodiments may be implemented in combinations.

With the present invention set forth above, in the ink-jet printing apparatus using pit-in supply method, problems associated with condensation of ink can be reduced or eliminated.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. An ink-jet printing apparatus having a main tank storing ink, a sub-tank releasably connectable with said main tank through an ink supply passage and a printing head for ejecting ink supplied from said sub-tank, for performing printing by ejecting ink from said printing head to a printing medium, comprising:
ink supply means for supplying ink from said main tank to said sub-tank through said ink supply passage within a period after completion of printing at preceding time and before starting printing at next time; and
ink draining means for performing ink draining for draining at least a part of ink remaining in said sub-tank within said period after completion of printing at preceding time and before starting printing at next time and in advance of ink supply by said ink supply means.

2. The ink-jet printing apparatus as claimed in claim 1, which further comprises:
measuring means for measuring any one of (A) a period after completion of printing at preceding time and before starting printing at next time and a power source being held OFF, (B) a period from turning OFF of the power source at preceding time to reception of a print start signal for starting printing at next time, (C) a period from completion of printing at preceding time to reception of a print start signal for starting printing at next time, and (D) a period after completion of recovery process at preceding time to reception of a print start signal for starting printing at next time; and
control means for controlling whether ink draining process by said ink draining means is to be performed or not on the basis of a period measured by said measuring means.

3. The ink-jet printing apparatus as claimed in claim 2, wherein said control means controls to perform ink draining process by said ink draining means when a measured period is longer than or equal to a predetermined period and controls not to perform ink draining process by said ink draining means when the measured period is shorter than said predetermined period.

4. The ink-jet printing apparatus as claimed in claim 1, which further comprises:
measuring means for measuring any one of (A) a period after completion of printing at preceding time and before starting printing at next time and a power source being held OFF, (B) a period from turning OFF of the power source at preceding time to reception of a print start signal for starting printing at next time, (C) a period from completion of printing at preceding time to reception of a print start signal for starting printing at next time, and (D) a period after completion of recovery process at preceding time to reception of a print start signal for starting printing at next time;
calculating means for calculating a value corresponding to an amount of remaining ink in said sub-tank at completion of printing at preceding time; and
control means for controlling whether ink draining process by said ink draining means is to be performed or not on the basis of a period measured by said measuring means and value corresponding to remaining ink amount calculated by said calculating means.

5. The ink-jet printing apparatus as claimed in claim 1, which further comprises:
measuring means for measuring any one of (A) a period after completion of printing at preceding time and before starting printing at next time and a power source being held OFF, (B) a period from turning OFF of the power source at preceding time to reception of a print start signal for starting printing at next time, (C) a period from completion of printing at preceding time to reception of a print start signal for starting printing at next time, and (D) a period after completion of recovery process at preceding time to reception of a print start signal for starting printing at next time;
calculating means for calculating a value corresponding to an amount of remaining ink in said sub-tank at completion of printing at preceding time; and
means for calculating a value corresponding to a viscosity of remaining ink in said sub-tank at completion of printing at preceding time;
calculating means for calculating a value corresponding a viscosity of current ink on the basis of the measured period, the calculated value corresponding to remaining ink amount and the calculated value corresponding to ink viscosity; and
control means for controlling whether ink draining process by said ink draining means is to be performed or not on the basis of the value corresponding to viscosity of the current ink.

6. The ink-jet printing apparatus as claimed in claim 5, which comprises:
detecting means for detecting temperature and humidity;
storage means for storing history of temperature and humidity during said period; and
correcting means for correcting a value corresponding to viscosity of said current ink on the basis of said history.

7. The ink-jet printing apparatus as claimed in claim 1, wherein ink supply is performed by said ink supply means to sub-tank containing said remaining ink before ink draining process by said ink draining means during a period after completion of printing at preceding time and before starting printing at next time.

8. The ink-jet printing apparatus as claimed in claim 7, which further comprises:
measuring means for measuring any one of (A) a period after completion of printing at preceding time and before starting printing at next time and a power source being held OFF, (B) a period from turning OFF of the power source at preceding time to reception of a print start signal for starting printing at next time, (C) a period from completion of printing at preceding time to reception of a print start signal for starting printing at next time, and (D) a period after completion of recovery process at preceding time to reception of a print start signal for starting printing at next time; and
control means for controlling to perform ink draining process after performing ink supply when a measured period is longer than or equal to a predetermined period and controlling not to perform ink supply and ink draining process by said ink draining means when said measured period is shorter than the predetermined period.

9. The ink-jet printing apparatus as claimed in claim 7, which further comprises:
measuring means for measuring any one of (A) a period after completion of printing at preceding time and before starting printing at next time and a power source being held OFF, (B) a period from turning OFF of the power source at preceding time to reception of a print start signal for starting printing at next time, (C) a period from completion of printing at preceding time to reception of a print start signal for starting printing at next time, and (D) a period after completion of recovery process at preceding time to reception of a print start signal for starting printing at next time;
calculating means for calculating a value corresponding to an amount of remaining ink in said sub-tank at completion of printing at preceding time; and
control means for controlling whether said ink draining process is to be performed after performing said ink supply or not to perform both of said ink supply before ink draining process and said ink draining process on the basis of a period measured by said measuring means and value corresponding to remaining ink amount calculated by said calculating means.

10. The ink-jet printing apparatus as claimed in claim 1, which further comprises:
measuring means for measuring any one of (A) a period after completion of printing at preceding time and before starting printing at next time and a power source being held OFF, (B) a period from turning OFF of the power source at preceding time to reception of a print start signal for starting printing at next time, (C) a period from completion of printing at preceding time to reception of a print start signal for starting printing at next time, and (D) a period after completion of recovery process at preceding time to reception of a print start signal for starting printing at next time;
calculating means for calculating a value corresponding to an amount of remaining ink in said sub-tank at completion of printing at preceding time; and
means for calculating a value corresponding to a viscosity of remaining ink in said sub-tank after completion of printing at preceding time;
calculating means for calculating a value corresponding a viscosity of current ink on the basis of the measured period, the calculated value corresponding to remaining ink amount and the calculated value corresponding to ink viscosity; and
control means for controlling whether said ink draining process is to be performed after performing said ink supply or not to perform both of said ink supply before ink draining process and said ink draining process on the basis of the value corresponding to viscosity of the current ink.

11. The ink-jet printing apparatus as claimed in claim 1, wherein said ink draining means drains substantially all amount of flowable ink in said sub-tank.

12. The ink-jet printing apparatus as claimed in claim 1, which performs warming process for elevating temperature of ink in said printing head and ink in said sub-tank before performing ink draining process by said ink draining means.

13. The ink-jet printing apparatus as claimed in claim 1, wherein ink draining process by said ink draining means is performed at one of a point of time taking turning OFF of a power source as trigger, a point of time taking reception of a print start signal for starting next print as trigger, and a point of time of reception of print start signal for starting first print after turning ON of power source.

14. The ink-jet printing apparatus as claimed in claim 1, wherein ink draining process by said ink draining means is performed at one of a point of time taking turning OFF of a power source as trigger and a point of time taking reception of a print end signal indicating end of printing.

15. An ink-jet printing apparatus having a plurality of main tanks storing inks, and a plurality of sub-tanks connected to a printing head and releasably connectable with said plurality of main tanks through respective ink supply passages, comprising:
calculating means for calculating remaining ink amount in each sub-tank at completion of printing operation; and
first draining control means f or controlling draining of ink from each sub-tank on the basis of results of calculation by said calculating means so that remaining ink amounts in said plurality of sub-tanks are substantially equal with each other.

16. The ink-jet printing apparatus as claimed in claim 15, wherein said first draining control means controls draining of ink from each sub-tank so that remaining ink amounts in respective of said sub-tanks become substantially equal amount at the minimum amount among remaining ink amounts calculated by said calculating means.

17. The ink-jet printing apparatus as claimed in claim 15, which further comprises:
comparing means for comparing mutual difference of remaining ink amounts in respective of said sub-tanks calculated by said calculating means with a predetermined value, and
said first draining control means controls draining depending upon result of comparison by said comparing means.

18. The ink-jet printing apparatus as claimed in claim 17, wherein said first draining control means controls draining of inks from respective sub-tanks so that remaining ink amounts in said plurality of sub-tanks become substantially equal value with each other when said difference is greater than said predetermined value.

19. The ink-jet printing apparatus as claimed in claim 15, which further comprises second draining control means for draining remaining inks in said plurality of sub-tanks an amount equal to each other after draining by said first draining control means and before starting next printing operation.

20. The ink-jet printing apparatus as claimed in claim 15, which further comprises negative pressure generating means for holding ink in said sub-tank, said negative pressure generating means is a porous body including foamed body or fibrous body.

21. The ink-jet printing apparatus as claimed in claim 16, wherein a plurality of main tanks store inks colors of which are different from each other.
